(19) United States
(12) Patent Application Publication
(10) Pub. No.: US 2025/0162062 A1
(43) Pub. Date: May 22, 2025

(54) JOINING DEVICE, JOINING METHOD AND MANUFACTURING METHOD OF BATTERY

(71) Applicant: KABUSHIKI KAISHA TOSHIBA, Tokyo (JP)

(72) Inventor: Takahiro Aizawa, Yokohama Kanagawa (JP)

(73) Assignee: KABUSHIKI KAISHA TOSHIBA, Tokyo (JP)

(21) Appl. No.: 18/944,935

(22) Filed: Nov. 12, 2024

(30) Foreign Application Priority Data
Nov. 17, 2023 (JP) 2023-196086

(51) Int. Cl. B23K 20/10; B23K 101/38; H01M 50/536; H01M 50/538

(52) U.S. Cl. CPC B23K 20/10; H01M 50/536; H01M 50/538; B23K 2101/38

(57) ABSTRACT

A joining device in an embodiment includes a controller, and, by controlling an operation of the joining device, the controller joins, for an electrode group where first and second current collecting bundle portions are arranged in a thickness direction with a gap interposed, the first current collecting bundle portion to a lead by applying pressure to the first current collecting bundle portion from at least one side in the thickness direction. By controlling, the controller joins, for the electrode group, the second current collecting bundle portion to the lead by applying pressure to the second current collecting bundle portion from at least one side in the thickness direction, the second current collecting bundle portion being joined while an attitude angle of the electrode group to a horizontal plane is maintained from an attitude of the electrode group during joining of the first current collecting bundle portion.

### CROSS-REFERENCE TO RELATED APPLICATION

This application is based upon and claims the benefit of priority from prior Japanese Patent Application No. 2023-196086, filed Nov. 17, 2023, the entire contents of which are incorporated herein by reference.

### FIELD

Embodiments described herein relate generally to a joining device, a joining method and a manufacturing method of a battery.

### BACKGROUND

In the manufacture of a battery, by joining a current collecting bundle portion, in which current collecting strip portions are bundled in an electrode group, to a lead, the current collecting bundle portion of the electrode group is connected to a terminal via the lead. In addition, as the battery, there is known such a battery that in the electrode group, two current collecting bundle portions are arranged in a thickness direction of the electrode group, with a gap interposed between the two current collecting bundle portions. In such a battery, the lead is connected to the two current collecting bundle portions, respectively, in a state in which the lead is adjacent to each of the two current collecting bundle portions from an opposite side to the side on which the gap is located.

In the manufacture of the battery in which the two current collecting bundle portions are arranged in the thickness direction in the electrode group, a first current collecting bundle portion that is one of the two current collecting bundle portions is joined to the lead by applying pressure to the first current collecting bundle portion from at least one side in the thickness direction by using a joining tool or the like. In addition, if the joining of the first current collecting bundle portion to the lead is finished, the electrode group is inverted in a vertical direction from the attitude of the electrode group during joining of the first current collecting bundle portion to the lead, for example, by rotating the electrode group around an axis along a horizontal plane. Then, in the electrode group that was inverted in the vertical direction from the attitude during joining of the first current collecting bundle portion, a second current collecting bundle portion that is the other of the two current collecting bundle portions is joined to the lead by applying pressure to the second current collecting bundle portion from at least one side in the thickness direction by using the joining tool or the like.

In a case of joining the second current collecting bundle portion by inverting the electrode group in the vertical direction from the attitude during joining of the first current collecting bundle portion, as described above, it is necessary to provide a mechanism for inverting the electrode group and a mechanism for suppressing a positional displacement of the electrode group due to the inversion of the electrode group. However, from the standpoint of suppressing an increase in size and weight of a device for manufacturing a battery, and from the standpoint of improving the throughput in the manufacture of the battery, it is required to properly join the two current collecting bundle portions arranged in the thickness direction in the electrode group to the lead, without providing the mechanism for inverting the electrode group and the mechanism for suppressing the positional displacement of the electrode group due to the inversion of the electrode group. In other words, it is required to properly join the two current collecting bundle portions arranged in the thickness direction in the electrode group to the lead, without inverting the electrode group in the vertical direction.

### BRIEF DESCRIPTION OF THE DRAWINGS

FIG. 1 is an exploded perspective view schematically illustrating an example of the configuration of a battery to be manufactured in embodiments or the like.

FIG. 2 is a schematic diagram illustrating an example of the configuration of an electrode group in the battery of the example of FIG. 1, by a cross section perpendicular or substantially perpendicular to a width direction of the electrode group.

FIG. 3 is a block diagram schematically illustrating an example of a manufacturing system of a battery in a first embodiment.

FIG. 4 is a schematic diagram for describing the joining of one of a pair of uncoated portions to a lead, the joining being performed by a joining process unit according to the first embodiment.

FIG. 5 is a schematic diagram illustrating a state in which one of two current collecting bundle portions in an uncoated portion that is one of a pair of uncoated portions is joined by using the joining process unit according to the first embodiment.

FIG. 6 is a schematic diagram illustrating a state in which the other of the two current collecting bundle portions in the uncoated portion that is one of the pair of uncoated portions is joined by using the joining process unit according to the first embodiment.

FIG. 7 is a block diagram schematically illustrating an example of a manufacturing system of a battery in a second embodiment.

FIG. 8 is a schematic diagram for describing a process performed by one piece of joining equipment of a joining process unit in the second embodiment.

FIG. 9 is a block diagram schematically illustrating an example of a manufacturing system of a battery in a third embodiment.

FIG. 10 is a schematic diagram for describing the joining of one of a pair of uncoated portions to a lead, the joining being performed by a joining process unit according to the third embodiment.

FIG. 11 is a schematic diagram illustrating a state in which one of two current collecting bundle portions in an uncoated portion that is one of a pair of uncoated portions is joined by using a joining process unit according to a modification of the first embodiment through the third embodiment.

FIG. 12 is a schematic diagram illustrating a state in which the other of the two current collecting bundle portions in the uncoated portion that is one of the pair of uncoated portions is joined by using the joining process unit according to the modification of the first embodiment through the third embodiment.

FIG. 13 is a block diagram schematically illustrating an example of a manufacturing system of a battery in a fourth embodiment.

FIG. 14 is a schematic diagram for describing the joining of one of a pair of uncoated portions to a lead, the joining being performed by a joining process unit according to the fourth embodiment.

FIG. 15 is a schematic diagram illustrating a state in which one of a pair of uncoated portions is joined in a fifth embodiment.

FIG. 16 is a schematic diagram for describing the joining of one of a pair of uncoated portions to a lead, the joining being performed by a joining process unit according to the fifth embodiment.

### DETAILED DESCRIPTION

According to an embodiment, a joining device includes a controller. The controller is configured to control an operation of the joining device so as to join, for an electrode group in which a first current collecting bundle portion and a second current collecting bundle portion are arranged in a thickness direction with a gap interposed, the first current collecting bundle portion to a lead by applying pressure to the first current collecting bundle portion from at least one side in the thickness direction. The controller is configured to control the operation of the joining device so as to join, for the electrode group, the second current collecting bundle portion to the lead by applying pressure to the second current collecting bundle portion from at least one side in the thickness direction, the second current collecting bundle portion being joined while an attitude angle of the electrode group with respect to a horizontal plane is maintained from an attitude of the electrode group during joining of the first current collecting bundle portion to the lead.

Hereinafter, embodiments are described with reference to the accompanying drawings.

### 1. Battery

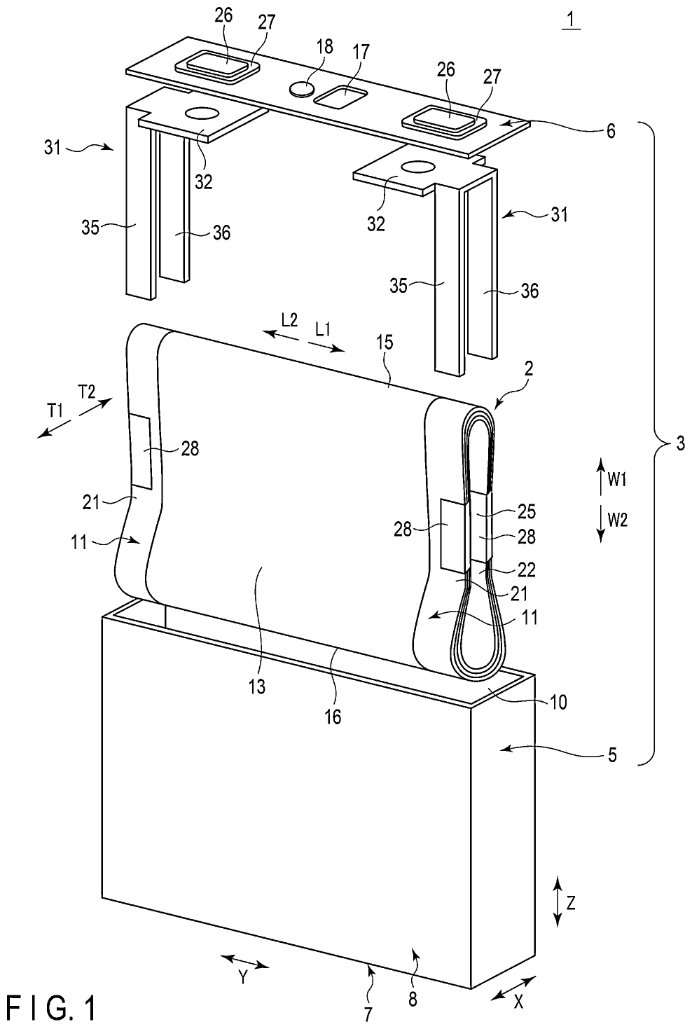

First, a battery to be manufactured in the embodiments or the like will be described. FIG. 1 illustrates an example of the configuration of a battery 1 to be manufactured in the embodiments or the like. The battery 1 of the example of FIG. 1 includes an electrode group 2 and a container unit 3. The container unit 3 includes an outer container 5 and a lid 6. Here, in the battery 1 and the outer container 5, a depth direction (a direction indicated by arrow X), a lateral direction (a direction indicated by arrow Y) crossing (perpendicular or substantially perpendicular to) the depth direction, and a height direction (a direction indicated by arrow Z) crossing (perpendicular or substantially perpendicular to) both the depth direction and the lateral direction, are defined. In each of the battery 1 and the outer container 5, a dimension along the depth direction is less than a dimension along the lateral direction and a dimension along the height direction. Note that FIG. 1 schematically illustrates the battery 1 by an exploded perspective view in which respective components are separated.

The outer container 5 includes a bottom wall 7 and a peripheral wall 8. In the inside of the outer container 5, an inner cavity 10 in which the electrode group 2 is housed is defined by the bottom wall 7 and peripheral wall 8. In the outer container 5, the inner cavity 10 opens toward an opposite side to the side where the bottom wall 7 is located in the height direction. The lid 6 is attached to the peripheral wall 8 at an end portion on an opposite side to the bottom wall 7. Thus, the lid 6 closes the opening of the inner cavity 10 of the outer container 5. The lid 6 and bottom wall 7 face each other, with the inner cavity 10 being interposed.

The electrode group 2 includes a positive electrode and a negative electrode. In the electrode group 2, a separator is interposed between the positive electrode and the negative electrode. In the electrode group 2, the separator is formed of a material having an electrical insulation property, and electrically insulates the positive electrode from the negative electrode. In the electrode group 2, the positive electrode includes a positive electrode current collector such as a positive electrode current collecting foil, and a positive electrode active material-containing layer coated (supported) on a surface of the positive electrode current collector. In addition, the positive electrode current collector includes an uncoated portion 11 on which the positive electrode active material-containing layer is not coated (not supported). Further, in the electrode group 2, the negative electrode includes a negative electrode current collector such as a negative electrode current collecting foil, and a negative electrode active material-containing layer coated (supported) on a surface of the negative electrode current collector. In addition, the negative electrode current collector includes an uncoated portion 11 on which the negative electrode active material-containing layer is not coated (not supported). Because of the above configuration, in the electrode group 2, the uncoated portion 11 of the positive electrode and the uncoated portion 11 of the negative electrode are formed as a pair of uncoated portions 11. Note that the uncoated portion 11 of the positive electrode is also referred to as “positive electrode uncoated portion”, and the uncoated portion 11 of the negative electrode is also referred to as “negative electrode uncoated portion”.

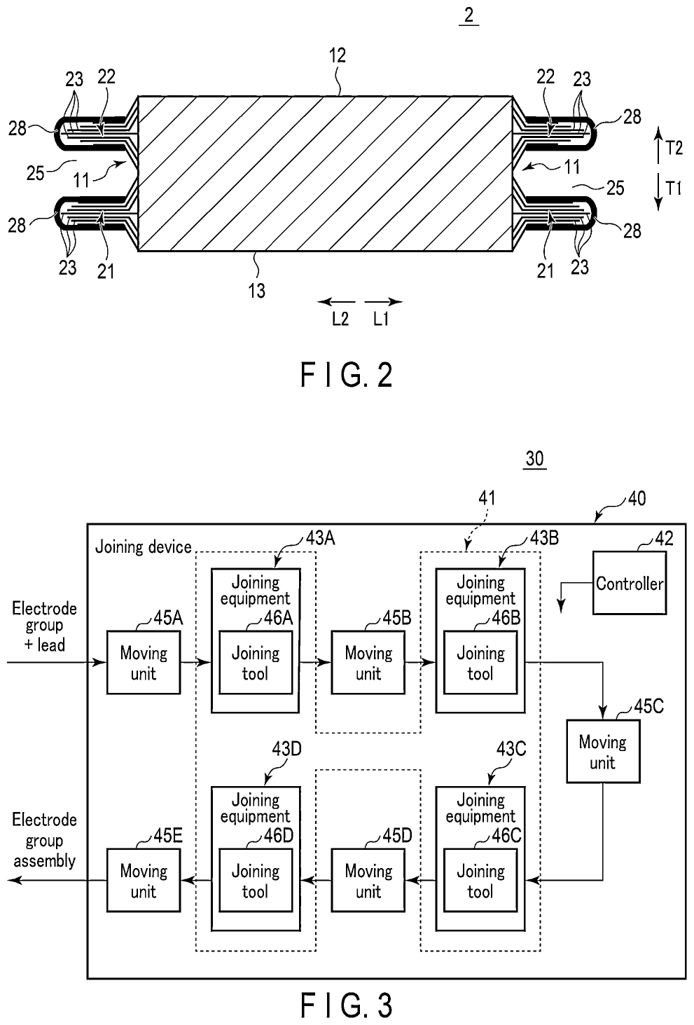

FIG. 2 schematically illustrates the configuration of the electrode group 2 in the battery 1 of the example of FIG. 1. As illustrated in FIG. 1 and FIG. 2, in the electrode group 2, a length direction (a direction indicated by arrow L1 and arrow L2), a width direction (a direction indicated by arrow W1 and arrow W2) crossing (perpendicular or substantially perpendicular to) the length direction, and a thickness direction (a direction indicated by arrow T1 and arrow T2) crossing (perpendicular or substantially perpendicular to) both the length direction and the width direction, are defined. In the electrode group 2, a dimension along the thickness direction is less than a dimension along the length direction and a dimension along the width direction. In addition, the electrode group 2 is formed in a flat shape. Note that FIG. 2 illustrates a cross section perpendicular or substantially perpendicular to the width direction of the electrode group 2.

In the example of FIG. 1, the electrode group 2 is formed with a so-called winding structure, and, in the electrode group 2, the positive electrode, negative electrode and separator are wound around a winding axis, in the state in which the separator is interposed between the positive electrode and the negative electrode. In addition, in the electrode group 2 of the winding structure, the winding axis extends along the length direction of the electrode group 2. Note that in one example, the electrode group 2 is formed with a so-called stack structure, and in the electrode group 2, a plurality of positive electrode plates and a plurality of negative electrode plates are alternately stacked in the thickness direction of the electrode group 2. In this case, in the electrode group 2, the positive electrode is composed of the positive electrode plates, and the negative electrode is composed of the negative electrode plates. Further, the positive electrode plates and the negative electrode plates are stacked in the state in which the separator is interposed between the mutually neighboring positive electrode plate and negative electrode plate in the thickness direction (stacking direction).

As illustrated in FIGS. 1 and 2, the electrode group 2 includes a pair of electrode group main surfaces 12 and 13. The electrode group main surface (first electrode group main surface) 12 faces one side in the thickness direction, and the electrode group main surface (second electrode group main surface) 13 faces a side opposite to the side toward which the electrode group main surface 12 faces in the thickness direction. Thus, the electrode group main surfaces 12 and 13 face mutually opposite sides in the thickness direction. In addition, the electrode group 2 includes a pair of electrode group edge surfaces 15 and 16. The electrode group edge surface (first electrode group edge surface) 15 faces one side in the width direction, and the electrode group edge surface (second electrode group edge surface) 16 faces a side opposite to the side toward which the electrode group edge surface 15 faces in the width direction. Thus, the electrode group edge surfaces 15 and 16 face mutually opposite sides in the width direction. In the electrode group 2, an end on one side in the width direction is formed by the electrode group edge surface 15, and an end on the opposite side to the electrode group edge surface 15 in the width direction is formed by the electrode group edge surface 16.

In the inner cavity 10, an electrolytic solution (not illustrated) is held (impregnated) in the electrode group 2. The electrolytic solution may be an aqueous electrolytic solution such as an aqueous solution, or may be a nonaqueous electrolytic solution including an electrolyte dissolved in an organic solvent. In addition, a gel electrolyte or a solid electrolyte may be used in place of the electrolytic solution. In a case where a solid electrolyte is used as the electrolyte, the separator may be formed of the solid electrolyte in the electrode group 2. In addition, in the example of FIG. 1, a gas release valve 17 and a liquid injection port (not illustrated) are formed in the lid 6. Further, a sealing plate 18 that closes the liquid injection port is welded on an outer surface of the lid 6. Note that the gas release valve 17 and the liquid injection port may not be provided in the battery 1.

In the example of FIG. 1 and FIG. 2, in the electrode group 2, the positive electrode uncoated portion (the uncoated portion 11 of the positive electrode) protrudes toward one side in the length direction of the electrode group 2. In addition, in the electrode group 2, the negative electrode uncoated portion (the uncoated portion 11 of the negative electrode) protrudes toward an opposite side in the length direction to the side on which the positive electrode uncoated portion protrudes. In each of the paired uncoated portions 11, two current collecting bundle portions 21 and 22 are formed. In other words, the two current collecting bundle portions 21 and 22 are formed in each of the positive electrode uncoated portion and the negative electrode uncoated portion. In each of the current collecting bundle portions 21 and 22, a plurality of current collecting strip portions 23 are stacked in the thickness direction of the electrode group 2, and the current collecting strip portions 23 are bundled. In each of the current collecting bundle portions 21, 22 of the positive electrode uncoated portion, each of the bundled current collecting strip portions 23 is formed of the positive electrode current collector. In addition, in each of the current collecting bundle portions 21, 22 of the negative electrode uncoated portion, each of the bundled current collecting strip portions 23 is formed of the negative electrode current collector.

In addition, in the electrode group 2, the current collecting bundle portions 21, 22 of the positive electrode uncoated portion protrude toward one side in the length direction of the electrode group 2, and the current collecting bundle portions 21, 22 of the negative electrode uncoated portion protrude toward an opposite side in the length direction to the side on which the positive electrode uncoated portion protrudes. Thus, in the positive electrode uncoated portion, the current collecting bundle portion (first current collecting bundle portion) 21 protrudes to a side on which the current collecting bundle portion (second current collecting bundle portion) 22 protrudes in the length direction of the electrode group 2. In addition, in the negative electrode uncoated portion, the current collecting bundle portion (first current collecting bundle portion) 21 protrudes to a side on which the current collecting bundle portion (second current collecting bundle portion) 22 protrudes in the length direction of the electrode group 2.

In addition, in each of the paired uncoated portions 11, a gap 25 is formed between the two current collecting bundle portions 21 and 22 in the thickness direction of the electrode group 2. Thus, in each of the paired uncoated portions 11, the current collecting bundle portions 21 and 22 are arranged in the thickness direction with the gap 25 being interposed, and the current collecting bundle portion (first current collecting bundle portion) 21 faces the current collecting bundle portion (second current collecting bundle portion) 22 in the thickness direction with the gap 25 being interposed.

In the battery 1 of the example of FIG. 1, the electrode group 2 is housed in the internal cavity 10 in a state in which the thickness direction of the electrode group 2 is along the depth direction of the battery 1, and the length direction of the electrode group 2 is along the lateral direction of the battery 1. In addition, the electrode group 2 is disposed in the internal cavity 10 in a state in which the width direction of the electrode group 2 is along the height direction of the battery 1. Since the electrode group 2 is disposed in the internal cavity 10 in this manner, in the battery 1 of the example of FIG. 1, the current collecting bundle portions 21, 22 of the positive electrode uncoated portion protrude toward one side in the lateral direction, and the current collecting bundle portions 21, 22 of the negative electrode uncoated portion protrude toward an opposite side in the lateral direction to the side on which the positive electrode uncoated portion protrudes. In addition, in each of the paired uncoated portions 11 of the electrode group 2, the two current collecting bundle portions 21 and 22 are arranged in the depth direction of the battery 1, with the gap 25 being interposed.

Additionally, in the battery 1 of the example of FIG. 1, a pair of terminals 26 are attached to the lid 6. Each of the paired terminals 26 is exposed to the outside of the battery 1, and is disposed on an outer surface of the lid 6. The terminals 26 are formed of an electrically conductive material such as a metal. One of the paired terminals 26 functions as a positive electrode terminal of the battery 1, and the other of the paired terminals 26, which is different from the positive electrode terminal, functions as a negative electrode terminal of the battery 1. Additionally, in the example of FIG. 1, an insulating member 27 is disposed between each of the paired terminals 26 and the lid 6 on the outer surface of the lid 6. Each of the paired terminals 26 is electrically insulated from the outer container 5 and lid 6 by the insulating member 27.

Additionally, in the example of FIG. 1, a pair of leads 31 are housed in the inner cavity 10 of the container unit 3. The paired leads 31 are formed of an electrically conductive material. One of the paired leads 31 functions as a positive electrode-side lead, and the other of the paired leads 31, which is different from the positive electrode-side lead, functions as a negative electrode-side lead. In the battery 1, the positive electrode terminal is connected to the positive electrode-side lead, and the negative electrode terminal is connected to the negative electrode-side lead. In addition, in the battery 1, the current collecting bundle portion 21, 22 of the positive electrode uncoated portion is joined to the positive electrode-side lead, and is electrically connected to the positive electrode terminal via the positive electrode-side lead. Additionally, the current collecting bundle portion 21, 22 of the negative electrode uncoated portion is joined to the negative electrode-side lead, and is electrically connected to the negative electrode terminal via the negative electrode-side lead. Accordingly, in each of the paired uncoated portions 11, the current collecting bundle portions 21 and 22 are joined to a corresponding one of the paired leads 31.

In the example of FIG. 1 and FIG. 2, in each of the paired uncoated portions 11, a clip (backup lead) 28 is attached to each of the two current collecting bundle portions 21 and 22. Each of the clips 28 is formed of an electrically conductive material. In each of the paired uncoated portions 11, each of the two current collecting bundle portions 21 and 22 is clamped by the clip 28 from both sides in the thickness direction of the electrode group 2. In addition, in each of the uncoated portions 11, each of the current collecting bundle portions 21 and 22, while being clamped by the clip 28, is joined to a corresponding one of the paired leads 31. Note that, in one example, the clip 28 is not provided, and the clip 28 is not attached to each of the current collecting bundle portions 21 and 22. In this case, in each of the uncoated portions 11, each of the two current collecting bundle portions 21 and 22 is directly joined to the corresponding one of the paired leads 31.

Additionally, in the example of FIG. 1, each of the paired leads 31 includes a top plate portion 32 and a pair of leg plate portions 35 and 36. In the inner cavity 10, the top plate portion 32 of each lead 31 is disposed between the lid 6 and the electrode group 2 in the height direction of the battery 1. In each of the leads 31, each of the pair of leg plate portions 35 and 36 is connected to the top plate portion 32. In addition, in the inner cavity 10, in each of the leads 31, each of the leg plate portions 35, 36 extends along the height direction of the battery 1 from a position of connection to the top plate portion 32 toward the side on which the bottom wall 7 is located. Additionally, in the inner cavity 10, in each of the leads 31, the paired leg plate portions 35 and 36 are spaced apart in the thickness direction of the electrode group 2 (the depth direction of the battery 1).

The leg plate portion 35 of the positive electrode-side lead neighbors the current collecting bundle portion (first current collecting bundle portion) 21 of the positive electrode uncoated portion, from an opposite side to the side on which the gap 25 is located in the thickness direction of the electrode group 2, and the current collecting bundle portion 21 of the positive electrode uncoated portion is joined to the leg plate portion 35 of the positive electrode-side lead. In addition, the leg plate portion 36 of the positive electrode-side lead neighbors the current collecting bundle portion (second current collecting bundle portion) 22, from an opposite side to the side on which the gap 25 is located in the thickness direction of the electrode group 2, and the current collecting bundle portion 22 of the positive electrode uncoated portion is joined to the leg plate portion 36 of the positive electrode-side lead.

Additionally, the leg plate portion 35 of the negative electrode-side lead neighbors the current collecting bundle portion (first current collecting bundle portion) 21 of the negative electrode uncoated portion, from an opposite side to the side on which the gap 25 is located in the thickness direction of the electrode group 2, and the current collecting bundle portion 21 of the negative electrode uncoated portion is joined to the leg plate portion 35 of the negative electrode-side lead. In addition, the leg plate portion 36 of the negative electrode-side lead neighbors the current collecting bundle portion (second current collecting bundle portion) 22 of the negative electrode uncoated portion, from an opposite side to the side on which the gap 25 is located in the thickness direction of the electrode group 2, and the current collecting bundle portion 22 of the negative electrode uncoated portion is joined to the leg plate portion 36 of the negative electrode-side lead.

Accordingly, in each of the paired uncoated portions 11, a corresponding one of the paired leads 31 neighbors each of the two current collecting bundle portions 21 and 22 from an opposite side to the side on which the gap 25 is located, and the corresponding one of the paired leads 31 is joined to each of the two current collecting bundle portions 21 and 22. Note that in the inner cavity 10 of the outer container 5, the paired uncoated portions 11 and the paired leads 31 are electrically insulated from the outer container 5 and lid 6 by at least one insulating member (not illustrated).

Additionally, in the example of FIG. 1, the container unit 3 is composed of the outer container 5 and lid 6, but the configuration or the like of the container unit 3 is not limited to this. In one example, the container unit 3 is composed of a laminate film. Additionally, in the example of FIGS. 1 and 2, or the like, the paired uncoated portions 11 protrude to mutually opposite sides in the length direction of the electrode group 2, but the example is not limited to this. In one example, in the electrode group 2, the negative electrode uncoated portion protrudes to the side on which the positive electrode uncoated portion protrudes in the length direction. In this case, the paired uncoated portions 11 are spaced apart from each other in the width direction of the electrode group, and are not in contact with each other.

In one example, the negative electrode uncoated portion protrudes to the side on which the positive electrode uncoated portion protrudes in the length direction of the electrode group 2. In addition, the electrode group 2 is disposed in the inner cavity 10 of the outer container 5 in a state in which the thickness direction of the electrode group 2 is along the depth direction of the battery 1, the length direction of the electrode group 2 is along the height direction of the battery 1, and the width direction of the electrode group 2 is along the lateral direction of the battery 1. In addition, in the inner cavity 10, the paired uncoated portions 11 (positive electrode uncoated portion and negative electrode uncoated portion) protrude to the side on which the lid 6 is located in the height direction of the battery 1.

However, in each of the examples, in each of the paired uncoated portions 11 of the electrode group 2, the two current collecting bundle portions 21 and 22 are arranged in the thickness direction of the electrode group 2 with the gap 25 being interposed. Furthermore, in each of the paired uncoated portions 11, each of the two current collecting bundle portions 21 and 22 is joined to a corresponding one of the paired leads 31 and electrically connected to a corresponding one of the paired terminals 26 via the corresponding one of the leads 31. Note that in a case where the container unit 3 is formed of a laminate film, and in a case where the negative electrode uncoated portion protrudes to the side on which the positive electrode uncoated portion protrudes, the shape or the like of each of the leads 31 differs from the example of FIG. 1.

Additionally, in the electrode group 2, it suffices that at least one of the paired uncoated portions 11, that is, at least one of the positive electrode uncoated portion and the negative electrode uncoated portion, has the same structure as in any one of the above-described examples. Accordingly, if such a configuration is adopted that the two current collecting bundle portions 21 and 22 in one of the paired uncoated portions 11 are arranged in the thickness direction of the electrode group 2 with the gap 25 being interposed, only one current collecting bundle portion may be formed in the other of the paired uncoated portions 11. Specifically, in the battery 1 to be manufactured in the embodiments or the like, it suffices that in the electrode group 2, the two current collecting bundle portions 21 and 22 are configured to be arranged in the thickness direction of the electrode group 2 with the gap 25 being interposed.

### 2. Manufacture of Battery

Hereinafter, a description is given of the manufacture of the above-described battery 1, that is, the manufacture of the battery 1 in which the two current collecting bundle portions 21 and 22 are arranged in the thickness direction of the electrode group 2 with the gap 25 being interposed. In the manufacture of the battery 1, the electrode group 2 is formed in the state in which the two current collecting bundle portions 21 and 22 are arranged in the thickness direction of the electrode group 2, in at least one of the paired uncoated portions 11. In addition, each of the paired uncoated portions 11 of the electrode group 2 is joined to a corresponding one of the paired leads 31. Furthermore, each of the paired uncoated portions 11 is electrically connected to a corresponding one of the paired terminals 26 via a corresponding one of the paired leads 31.

At this time, in the uncoated portion 11 in which the two current collecting bundle portions 21 and 22 are arranged in the thickness direction of the electrode group 2, the lead 31 is made to neighbor each of the two current collecting bundle portions 21 and 22 from the opposite side to the side on which the gap 25 is located in the thickness direction of the electrode group 2. Furthermore, each of the two current collecting bundle portions 21 and 22 is joined to the lead 31, and is electrically connected to the terminal 26 via the lead 31. In one example, in a state in which a corresponding one of the paired terminals 26 is connected to each of the paired leads 31, each of the paired uncoated portions 11 is joined to the corresponding one of the leads 31. In another example, after each of the paired uncoated portions 11 is joined to the corresponding one of the paired leads 31, the corresponding one of the paired terminals 26 is connected to each of the leads 31.

In the manufacture of the battery 1 of the example of FIG. 1, in the state in which each of the paired uncoated portions 11 is electrically connected to the corresponding one of the paired terminals 26 via the corresponding one of the paired leads 31, the electrode group 2 and paired leads 31 are housed in the inner cavity 10 of the outer container 5. In addition, in the state in which the electrode group 2 and leads 31 are housed in the inner cavity 10, the lid 6 is attached to the peripheral wall 8 of the outer container 5, and the opening of the inner cavity 10 is closed by the lid 6. Further, the battery 1 is manufactured by performing a predetermined process including filling of an electrolytic solution into the inner cavity 10. Hereinafter, a process of joining each of the uncoated portions 11 to the corresponding one of the leads 31 is described. In particular, a description is mainly given of a process of joining each of the current collecting bundle portions 21 and 22 to the lead 31 in the uncoated portion 11 in which the two current collecting bundle portions 21 and 22 are formed.

### First Embodiment

To begin with, a first embodiment is described as an example of a process of joining each of the uncoated portions 11 to a corresponding one of the leads 31. In the present embodiment, it is assumed that two current collecting bundle portions 21 and 22 are arranged in the thickness direction of the electrode group 2, with the gap 25 being interposed, in both of the paired uncoated portions 11, that is, in both of the positive electrode uncoated portion and the negative electrode uncoated portion. Additionally, as in the example of FIGS. 1 and 2, or the like, it is assumed that the paired uncoated portions 11 protrude to mutually opposite sides in the length direction of the electrode group 2. In the description below, one of the paired uncoated portions 11, that is, one of the positive electrode uncoated portion and the negative electrode uncoated portion, is also described as an uncoated portion (first uncoated portion) 11A, and the other of the paired uncoated portions 11, which is different from the uncoated portion 11A, is also described as an uncoated portion (second uncoated portion) 11B.

FIG. 3 schematically illustrates, by a block diagram, an example of a manufacturing system 30 of the battery 1 according to the present embodiment. As illustrated in FIG. 3, the manufacturing system 30 includes a joining device 40. The joining device 40 performs a part of a process in the manufacturing process of the battery 1 by using the electrode group 2 and the paired leads 31. Specifically, the joining device 40 performs a process of joining each of the paired uncoated portions 11 of the electrode group 2 to a corresponding one of the paired leads 31. By the process in the joining device 40, an electrode assembly, in which each of the uncoated portions 11 is joined to the corresponding one of the leads 31, is formed.

As illustrated in FIG. 3, the joining device 40 includes a joining process unit 41 and a controller 42. In addition, in the present embodiment, the joining process unit 41 is composed of four pieces of joining equipment 43A to 43D, and the joining device 40 is provided with five moving units 45A to 45E. The controller 42 controls the overall operation of the joining device 40, and controls the operation of the joining process unit 41 including the pieces of joining equipment 43A to 43D, and the operation of the moving units 45A to 45E. Thereby, the process of joining each of the paired uncoated portions 11 of the electrode group 2 to the corresponding one of the paired leads 31 is controlled by the controller 42.

The controller 42 includes a processor or an integrated circuit (control circuit) including a CPU (central processing unit), an ASIC (application specific integrated circuit), or an FPGA (field programmable gate array), and a storage medium (non-transitory storage medium) such as a memory. The controller 42 may include only one integrated circuit or the like, or may include a plurality of integrated circuits or the like. The controller 42 performs a process by executing a program or the like stored in the storage medium or the like. Operation control or the like by the controller 42 may be executed by an integrated circuit or the like of one computer or may be executed cooperatively by integrated circuits or the like of a plurality of computers. Additionally, the operation control by the controller 42 may be executed by a server or the like in a cloud environment.

In the present embodiment, in the joining device 40, the electrode group 2 and the paired leads 31 are conveyed into the joining equipment 43A by the moving unit 45A. Then, the joining equipment 43A joins the current collecting bundle portion (first current collecting bundle portion) 21 of the uncoated portion 11A to a corresponding one of the leads 31, and joins, for example, the current collecting bundle portion 21 of the positive electrode uncoated portion to the positive electrode-side lead. Further, responding to the end of the joining of the current collecting bundle portion 21 of the uncoated portion 11A to the lead 31, the moving unit 45B moves the electrode group 2 and the paired leads 31 from the joining equipment 43A to the joining equipment 43B. Then, the joining equipment 43B joins the current collecting bundle portion (second current collecting bundle portion) 22 of the uncoated portion 11A to a corresponding one of the leads 31, and joins, for example, the current collecting bundle portion 22 of the positive electrode uncoated portion to the positive electrode-side lead.

In addition, in the joining device 40, responding to the end of the joining of the current collecting bundle portion 22 of the uncoated portion 11A to the lead 31, the moving unit 45C moves the electrode group 2 and the paired leads 31 from the joining equipment 43B to the joining equipment 43C. Then, the joining equipment 43C joins the current collecting bundle portion (first current collecting bundle portion) 21 of the uncoated portion 11B to a corresponding one of the leads 31, and joins, for example, the current collecting bundle portion 21 of the negative electrode uncoated portion to the negative electrode-side lead. Further, responding to the end of the joining of the current collecting bundle portion 21 of the uncoated portion 11B to the lead 31, the moving unit 45D moves the electrode group 2 and the paired leads 31 from the joining equipment 43C to the joining equipment 43D. Then, the joining equipment 43D joins the current collecting bundle portion (second current collecting bundle portion) 22 of the uncoated portion 11B to a corresponding one of the leads 31, and joins, for example, the current collecting bundle portion 22 of the negative electrode uncoated portion to the negative electrode-side lead.

In addition, in the joining device 40, responding to the end of the joining of the current collecting bundle portion 22 of the uncoated portion 11B to the lead 31, the moving unit 45E moves the electrode group 2 and the paired leads 31 from the joining equipment 43D. Thereby, an electrode group assembly, in which each of the uncoated portions 11 is joined to the corresponding one of the leads 31, is conveyed out from the joining device 40. In one example, in each of the moving units 45A to 45E, the electrode group 2 and the leads 31 are held by a robot arm or the like, and the electrode group 2 and the leads 31 are moved. In another example, in each of the moving units 45A to 45E, the electrode group 2 and the leads 31 are moved by conveyance using a belt conveyor.

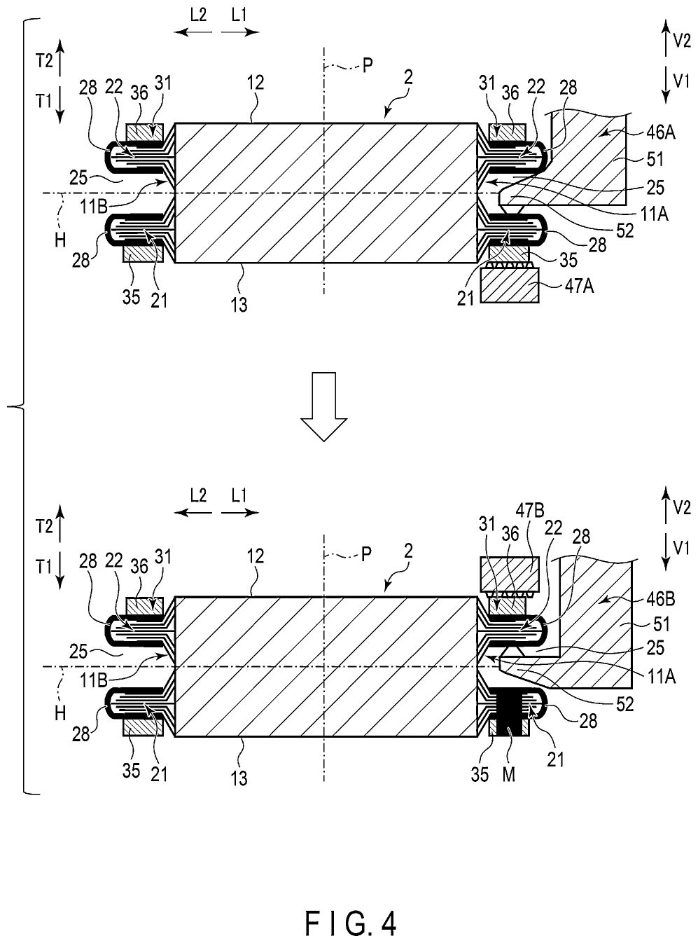

FIG. 4 is a diagram for describing the joining of the uncoated portion (first uncoated portion) 11A, which is one of the paired uncoated portions 11, to the lead 31, the joining being performed by the joining process unit 41. FIG. 4 schematically illustrates a state in which the current collecting bundle portion 21 of the uncoated portion 11A is being joined to the lead 31, and a state in which the current collecting bundle portion 22 of the uncoated portion 11A is being joined to the lead 31. In addition, FIG. 4 illustrates the electrode group 2 by a cross section perpendicular or substantially perpendicular to the width direction. Here, a vertical direction (a direction indicated by arrow V1 and arrow V2) is defined, and a side on which gravitation acts in the vertical direction is defined as a vertically lower side (arrow V1 side). In addition, an opposite side to the vertically lower side in the vertical direction is defined as a vertically upper side (arrow V2 side), and an imaginary horizontal plane H perpendicular to the vertical direction is defined.

In addition, an attitude angle is defined as a parameter relating to the attitude of the electrode group 2. The attitude angle indicates an inclined state of the electrode group 2 with respect to the horizontal plane H, and is expressed by a pitch angle and a roll angle. If two axes extending along the horizontal plane H and being perpendicular to each other are defined, the pitch angle indicates an inclined state (angular position) of the electrode group 2 around one of the two axes, and the roll angle indicates an inclined state (angular position) of the electrode group 2 around the other of the two axes. Additionally, an azimuth angle or a yaw angle is defined as a parameter relating to the attitude of the electrode group 2. The azimuth angle or yaw angle indicates an angular position of the electrode group 2 around an axis along the vertical direction.

As illustrated in FIG. 4, in the joining device 40 of the present embodiment, in the joining equipment 43A, the joining of the current collecting bundle portion 21 of the uncoated portion 11A is performed in a state in which the length direction and width direction of the electrode group 2 are along the horizontal plane H, and the thickness direction of the electrode group 2 is along the vertical direction. In addition, at such an attitude of the electrode group 2 that the electrode group main surface (first electrode group main surface) 12 faces the vertically upper side and the electrode group main surface (second electrode group main surface) 13 faces the vertically lower side, pressure is applied to the current collecting bundle portion (first current collecting bundle portion) 21 from at least one side in the thickness direction of the electrode group 2 in the uncoated portion 11A, and the current collecting bundle portion 21 is joined to the lead 31. Note that in FIG. 4, a joined portion M, in which the current collecting bundle portion 21 of the uncoated portion 11A was joined to the lead 31, is indicated by black coloring.

In addition, in the present embodiment, in the joining equipment 43B, at such an attitude of the electrode group 2 that the electrode group main surface (first electrode group main surface) 12 faces the vertically upper side, the joining of the current collecting bundle portion (second current collecting bundle portion) 22 of the uncoated portion 11A is performed. In addition, in the joining of the current collecting bundle portion 22 of the uncoated portion 11A to the lead 31, while the state in which the electrode group main surface 12 faces the vertically upper side is maintained from the attitude of the electrode group 2 during joining of the current collecting bundle portion 21 of the uncoated portion 11A to the lead 31, pressure is applied to the current collecting bundle portion 22 of the uncoated portion 11A from at least one side in the thickness direction of the electrode group 2. Thus, in the joining of the current collecting bundle portion 22 of the uncoated portion 11A, the attitude angle (pitch angle and roll angle) of the electrode group 2 with respect to the horizontal plane H is maintained from the attitude of the electrode group 2 during joining of the current collecting bundle portion 21 of the uncoated portion 11A.

Since the current collecting bundle portion 21, 22 of the uncoated portion 11A is joined to the lead 31, as described above, the moving unit 45B moves the electrode group 2 from the joining equipment 43A to the joining equipment 43B, while the attitude angle of the electrode group 2 with respect to the horizontal plane H is maintained from the attitude of the electrode group 2 during joining of the current collecting bundle portion 21 to the lead 31. Thus, the electrode group 2 does not rotate around the axis crossing the vertical direction, and, for example, does not rotate around the axis along the horizontal plane H, until the joining of the current collecting bundle portion 22 of the uncoated portion 11A ends from the start of the joining of the current collecting bundle portion 21 of the uncoated portion 11A. Accordingly, without inverting the electrode group 2 in the vertical direction from the joining of the current collecting bundle portion 21 of the uncoated portion 11A, the current collecting bundle portion 22 of the uncoated portion 11A is joined.

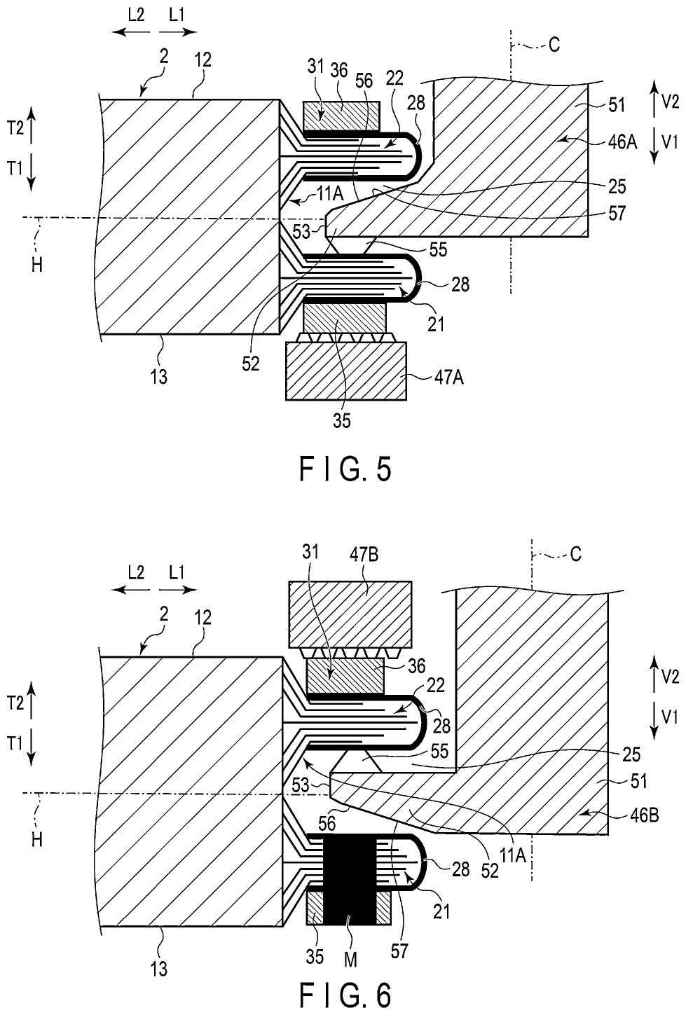

FIG. 5 illustrates a state in which the current collecting bundle portion (first current collecting bundle portion) 21, which is one of the two the current collecting bundle portions 21 and 22, is being joined in the uncoated portion (first uncoated portion) 11A, which is one of the paired uncoated portions 11, by using the joining process unit 41. FIG. 6 illustrates a state in which the current collecting bundle portion (second current collecting bundle portion) 22, which is the other of the two the current collecting bundle portions 21 and 22, is being joined in the uncoated portion (first uncoated portion) 11A, which one of the paired uncoated portions 11, by using the joining process unit 41. In FIG. 5 and FIG. 6, the electrode group 2 is illustrated by a cross section perpendicular or substantially perpendicular to the width direction, and the uncoated portion 11A of the electrode group 2 and a vicinity thereof are illustrated. In addition, in FIG. 6, a joined portion M, in which the current collecting bundle portion 21 of the uncoated portion 11A was joined to the lead 31, is indicated by black coloring.

As illustrated in FIGS. 3 to 6, or the like, in the joining process unit 41, the joining equipment 43A includes a joining tool (first joining tool) 46A, and the joining equipment 43B includes a joining tool (second joining tool) 46B that is different from the joining tool 46A. In the joining equipment 43A, the current collecting bundle portion 21 of the uncoated portion 11A is joined by using the joining tool 46A, and in the joining equipment 43B, the current collecting bundle portion 22 of the uncoated portion 11A is joined by using the joining tool 46B. In addition, the moving unit 45B moves the electrode group 2 from the position where the joining was performed by the joining tool 46A to the position where the joining is to be performed by the joining tool 46B.

In the joining equipment 43A, in the joining of the current collecting bundle portion 21 of the uncoated portion 11A to the lead 31, the joining tool 46A is inserted into the gap 25 between the current collecting bundle portions 21 and 22 of the uncoated portion 11A. Then, pressure is applied to the current collecting bundle portion 21 of the uncoated portion 11A from the joining tool 46A that is inserted in the gap 25. At this time, the joining tool 46A applies pressure toward one side in the vertical direction, and, in the example of FIG. 4 and FIG. 5, the joining tool 46A applies pressure toward the vertically lower side. In addition, in the joining of the current collecting bundle portion 21 of the uncoated portion 11A, ultrasonic vibration is transmitted in the joining tool 46A, and the joining tool 46A joins the current collecting bundle portion 21 to the lead 31 by applying the ultrasonic vibration to the current collecting bundle portion 21 of the uncoated portion 11A.

Additionally, the joining equipment 43A includes a stage 47A. In the joining equipment 43A, the current collecting bundle portion 21 is joined to the lead 31 in a state in which the current collecting bundle portion 21 of the uncoated portion 11A and the lead 31 are clamped between the joining tool 46A and the stage 47A in the vertical direction. In the joining of the current collecting bundle portion 21 of the uncoated portion 11A, the stage 47A is positioned to neighbor the lead 31 from an opposite side to the side on which the gap 25 is located, and in the example of FIG. 4 and FIG. 5, the stage 47A is positioned to neighbor the lead 31 from the vertically lower side. Note that in one example, pressure is applied from the stage 47A to the current collecting bundle portion 21 of the uncoated portion 11A, and pressure is applied to the current collecting bundle portion 21 from an opposite side to the gap 25. In another example, pressure is applied to the current collecting bundle portion 21 of the uncoated portion 11A from both the joining tool 46A and the stage 47A. In each case, however, pressure is applied to the current collecting bundle portion 21 of the uncoated portion 11A from at least one side in the thickness direction of the electrode group 2, and pressure is applied to the current collecting bundle portion 21 in the state in which the joining tool 46A is inserted in the gap 25.

In the joining equipment 43B, in the joining of the current collecting bundle portion 22 of the uncoated portion 11A to the lead 31, the joining tool 46B is inserted into the gap 25 between the current collecting bundle portions 21 and 22 of the uncoated portion 11A. Then, pressure is applied to the current collecting bundle portion 22 of the uncoated portion 11A from the joining tool 46B that is inserted in the gap 25. At this time, the joining tool 46B applies pressure toward an opposite side to the side toward which the pressure is applied by the joining tool 46A in the vertical direction, and, in the example of FIG. 4 and FIG. 6, the joining tool 46B applies pressure toward the vertically upper side. In addition, in the joining of the current collecting bundle portion 22 of the uncoated portion 11A, ultrasonic vibration is transmitted in the joining tool 46B, and the joining tool 46B joins the current collecting bundle portion 22 to the lead 31 by applying the ultrasonic vibration to the current collecting bundle portion 22 of the uncoated portion 11A.

Additionally, the joining equipment 43B includes a stage 47B. In the joining equipment 43B, the current collecting bundle portion 22 is joined to the lead 31 in a state in which the current collecting bundle portion 22 of the uncoated portion 11A and the lead 31 are clamped between the joining tool 46B and the stage 47B in the vertical direction. In the joining of the current collecting bundle portion 22 of the uncoated portion 11A, the stage 47B is positioned to neighbor the lead 31 from an opposite side to the side on which the gap 25 is located, and in the example of FIG. 4 and FIG. 6, the stage 47B is positioned to neighbor the lead 31 from the vertically upper side. Note that in one example, pressure is applied from the stage 47B to the current collecting bundle portion 22 of the uncoated portion 11A, and pressure is applied to the current collecting bundle portion 22 from an opposite side to the gap 25. In another example, pressure is applied to the current collecting bundle portion 22 of the uncoated portion 11A from both the joining tool 46B and the stage 47B. In each case, however, pressure is applied to the current collecting bundle portion 22 of the uncoated portion 11A from at least one side in the thickness direction of the electrode group 2, and pressure is applied to the current collecting bundle portion 22 in the state in which the joining tool 46B is inserted in the gap 25.

As illustrated in FIG. 5 and FIG. 6, or the like, each of the joining tools 46A and 46B includes a tool body 51 and a joining tip portion 52. In each of the joining tools 46A and 46B, the tool body 51 has a center axis C, and extends from a proximal side to a distal side along the center axis C, i.e., along the axial direction. In addition, in each of the joining tools 46A and 46B, the joining tip portion 52 is connected to a distal portion of the tool body 51. Note that in each of the joining tools 46A and 46B, if ultrasonic vibration or the like can be transmitted from the tool body 51 to the joining tip portion 52, the joining tip portion 52 may be formed as one piece with the tool body 51, or may be formed as a separate member from the tool body 51. In the example of FIG. 5 and FIG. 6, or the like, in each of the joining tools 46A and 46B, the joining tip portion 52 is bent with respect to the tool body 51, and is bent in a direction crossing (perpendicular to substantially perpendicular to) the axial direction (center axis C) of the tool body 51.

In the joining tip portion 52 of each of the joining tools 46A and 46B, a distal direction and a thickness direction crossing (perpendicular to substantially perpendicular to) the distal direction are defined. In each of the joining tools 46A and 46B, the joining tip portion 52 extends toward the distal direction from a connection portion to the tool body 51. In each of the joining tools 46A and 46B, an outer surface of the joining tip portion 52 includes a distal surface 53, and, in the joining tip portion 52 of each of the joining tools 46A and 46B, a distal end is formed by the distal surface 53.

In addition, in each of the joining tools 46A and 46B, the outer surface of the joining tip portion 52 includes a projection 55 and a back surface 56. In the joining tip portion 52 of each of the joining tools 46A and 46B, the projection 55 protrudes to one side in the thickness direction of the joining tip portion 52, and the back surface 56 faces an opposite side to the side on which the projection 55 protrudes in the thickness direction of the joining tip portion 52. In the joining tip portion 52 of each of the joining tools 46A and 46B, an inclined surface 57 is formed on the back surface 56, and the inclined surface 57 is inclined with respect to the distal direction of the joining tip portion 52. In addition, in the joining tip portion 52 of each of the joining tools 46A and 46B, the inclined surface 57 extends closer to the side on which the projection 55 protrudes in the thickness direction of the joining tip portion 52, as the inclined surface 57 extends closer to the distal end (distal surface 53) of the joining tip portion 52.

In the joining of the current collecting bundle portion 21 of the uncoated portion 11A to the lead 31, the joining equipment 43A inserts the joining tip portion 52 of the joining tool 46A from the distal end thereof into the gap 25 between the current collecting bundle portions 21 and 22 of the uncoated portion 11A. At this time, in the joining tool 46A, the joining tip portion 52 is inserted in the gap 25 in a state in which the axial direction (center axis C) of the tool body 51 is along the vertical direction. In addition, the joining tip portion 52 of the joining tool 46A is inserted in the gap 25 at such an attitude that the projection 55 protrudes toward the current collecting bundle portion (first current collecting bundle portion) 21, and the back surface 56 faces the current collecting bundle portion (second current collecting bundle portion) 22. In the joining of the current collecting bundle portion 21 of the uncoated portion 11A, pressure and ultrasonic vibration are applied to the current collecting bundle portion 21 via the projection 55 of the joining tip portion 52 of the joining tool 46A.

In addition, in the joining of the current collecting bundle portion 22 of the uncoated portion 11A to the lead 31, the joining equipment 43B inserts the joining tip portion 52 of the joining tool 46B from the distal end thereof into the gap 25 between the current collecting bundle portions 21 and 22 of the uncoated portion 11A. At this time, in the joining tool 46B, the joining tip portion 52 is inserted in the gap 25 in a state in which the axial direction (center axis C) of the tool body 51 is along the vertical direction. In addition, the joining tip portion 52 of the joining tool 46B is inserted in the gap 25 at such an attitude that the projection 55 protrudes toward the current collecting bundle portion (second current collecting bundle portion) 22, and the back surface 56 faces the current collecting bundle portion (first current collecting bundle portion) 21. In the joining of the current collecting bundle portion 22 of the uncoated portion 11A, pressure and ultrasonic vibration are applied to the current collecting bundle portion 22 via the projection 55 of the joining tip portion 52 of the joining tool 46B.

Furthermore, as illustrated in FIG. 3 or the like, in the joining process unit 41 of the present embodiment, the joining equipment 43C includes a joining tool 46C different from the joining tools 46A and 46B, and the joining equipment 43D includes a joining tool 46D different from the joining tools 46A to 46C. In the joining equipment 43C, the joining of the current collecting bundle portion 21 of the uncoated portion 11B is performed by using the joining tool 46C, and in the joining equipment 43D, the joining of the current collecting bundle portion 22 of the uncoated portion 11B is performed by using the joining tool 46D. Additionally, the moving unit 45D moves the electrode group 2 from the position where the joining was performed by the joining tool 46C to the position where the joining is to be performed by the joining tool 46D.

Each of the joining tools 46C and 46D, like the joining tools 46A and 46B, includes a tool body 51 and a joining tip portion 52. In addition, in each of the joining tools 46C and 46D, like the joining tools 46A and 46B, the joining tip portion 52 includes a distal surface 53, a projection 55 and a back surface 56, and an inclined surface 57 is formed on the back surface 56.

Also in the joining equipment 43C, the joining of the current collecting bundle portion 21 of the uncoated portion 11B is performed at such an attitude of the electrode group 2 that the electrode group main surface (first electrode group main surface) 12 faces the vertically upper side. At this time, like the joining of the current collecting bundle portion 21 of the uncoated portion 11A in the joining equipment 43A, the current collecting bundle portion 21 of the uncoated portion 11B is joined to the lead 31. In addition, in the joining equipment 43C, using a stage similar to the stage 47A, the current collecting bundle portion 21 is joined to the lead 31 in a state in which the current collecting bundle portion 21 of the uncoated portion 11B and the lead 31 are clamped between the joining tool 46C and the stage in the vertical direction.

Furthermore, also in the joining equipment 43D, the joining of the current collecting bundle portion 22 of the uncoated portion 11B is performed at such an attitude of the electrode group 2 that the electrode group main surface (first electrode group main surface) 12 faces the vertically upper side. At this time, like the joining of the current collecting bundle portion 22 of the uncoated portion 11A in the joining equipment 43B, the current collecting bundle portion 22 of the uncoated portion 11B is joined to the lead 31. In addition, in the joining equipment 43D, using a stage similar to the stage 47B, the current collecting bundle portion 22 is joined to the lead 31 in a state in which the current collecting bundle portion 22 of the uncoated portion 11B and the lead 31 are clamped between the joining tool 46D and the stage in the vertical direction.

As described above, in the present embodiment, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the pieces of joining equipment 43A to 43D, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H. Further, each of the moving units 45B, 45C and 45D moves the electrode group 2 while maintaining the attitude angle of the electrode group 2 with respect to the horizontal plane H in the state in which the electrode group main surface 12 faces the vertically upper side.

Note that in the present embodiment, while the joining of the four current collecting bundle portions 21 and 22 is being performed, if the attitude angle of the electrode group 2 is maintained in the state in which the electrode group main surface 12 faces the vertically upper side, the azimuth angle (yaw angle) of the electrode group 2 may be varied. In one example, in the process of moving the electrode group 2 by any one of the moving units 45B, 45C and 45D, the angular position of the electrode group 2 around the axis P is varied by rotating the electrode group 2 around the axis P (see FIG. 4) extending in the vertical direction. However, even if the electrode group 2 is rotated around the axis P, the attitude angle of the electrode group 2 is maintained in the state in which the electrode group main surface 12 faces the vertically upper side.

Because of the above-described configuration, in the present embodiment, even in such a configuration that the two current collecting bundle portions 21 and 22 in each of the paired uncoated portions 11 are arranged in the thickness direction of the electrode group 2 with the gap 25 being interposed, the current collecting bundle portions 21, 22 are appropriately joined to the lead 31 without inverting the electrode group 2 in the vertical direction. Specifically, by using the joining device 40 of the present embodiment, the two current collecting bundle portions 21 and 22 arranged in the thickness direction in the electrode group 2 can appropriately be joined to the lead 31, without inverting the electrode group 2 in the vertical direction.

Additionally, in the present embodiment, there is no need to provide the joining device 40 with a mechanism for inverting the electrode group 2 in the vertical direction, or a mechanism for suppressing a positional displacement of the electrode group 2 due to the inversion of the electrode group 2. Thus, an increase in size and weight of an apparatus, which includes the joining device 40 and manufactures the battery 1, can appropriately be suppressed. Additionally, since the mechanism for inverting the electrode group 2 or the mechanism for suppressing a positional displacement of the electrode group 2 due to the inversion of the electrode group 2 is not provided, the cost in the manufacture of the battery 1 is reduced, and the throughput in the manufacture of the battery 1 is improved.

Additionally, in the present embodiment, in each of the joining tools 46A and 46C, the above-described inclined surface 57 is formed on the back surface 56 of the joining tip portion 52. In addition, in a case where the current collecting bundle portion (first current collecting bundle portion) 21 is joined to the lead 31 in each of the uncoated portions 11, the joining tip portion 52 of the joining tool (46A or 46C) is inserted in the gap 25 at the attitude at which the back surface 56 faces the current collecting bundle portion (second current collecting bundle portion) 22. Thereby, in the joining of the current collecting bundle portion 21 to the lead 31, the joining tool (46A or 46C) is appropriately prevented from abutting on the current collecting bundle portion 22 and the clip 28 that is attached to the current collecting bundle portion 22.

Additionally, in the present embodiment, in each of the joining tools 46B and 46D, the above-described inclined surface 57 is formed on the back surface 56 of the joining tip portion 52. In addition, in a case where the current collecting bundle portion (second current collecting bundle portion) 22 is joined to the lead 31 in each of the uncoated portions 11, the joining tip portion 52 of the joining tool (46B or 46D) is inserted in the gap 25 at the attitude at which the back surface 56 faces the current collecting bundle portion (first current collecting bundle portion) 21. Thereby, in the joining of the current collecting bundle portion 22 to the lead 31, the joining tool (46B or 46D) is appropriately prevented from abutting on the current collecting bundle portion 21 and the clip 28 that is attached to the current collecting bundle portion 21.

Additionally, in the present embodiment, in the joining tip portion 52 of each of the joining tools 46A to 46D, a projection or the like is not provided on the back surface 56 that faces an opposite side to the side on which the projection 55 protrudes. Thus, in the joining tip portion 52 of each of the joining tools 46A to 46D, the dimension of that part of the joining tip portion 52 in the thickness direction thereof, which excludes the projection 55, is secured to a certain magnitude. Thereby, the rigidity of the joining tip portion 52 of each of the joining tools 46A to 46D is appropriately secured. Additionally, in the joining tip portion 52 of each of the joining tools 46A to 46D, since a projection or the like is not provided on the back surface 56, the joining tip portion 52 can more easily be inserted in the gap 25 between the current collecting bundle portions 21 and 22.

### Second Embodiment

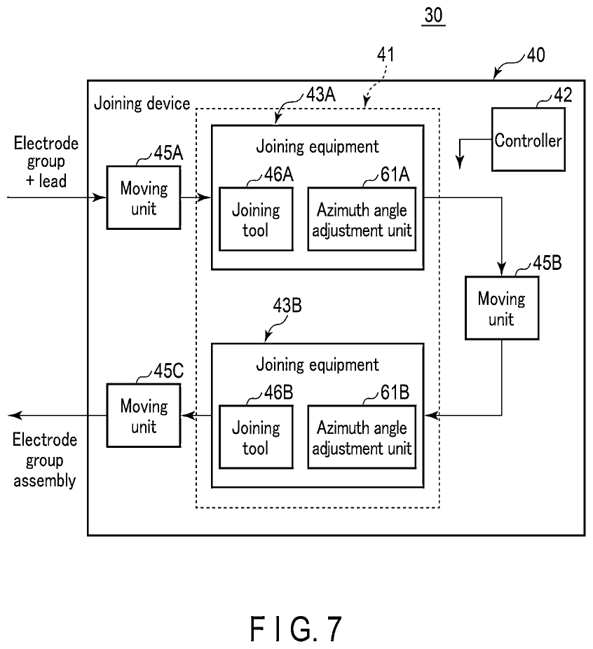

Next, as a modification of the first embodiment, a second embodiment is described. FIG. 7 schematically illustrates, by a block diagram, an example of a manufacturing system 30 of a battery 1 in the present embodiment. As illustrated in FIG. 7, also in the present embodiment, the joining device 40 of the manufacturing system 30 includes the joining process unit 41 and controller 42. However, in the present embodiment, the joining process unit 41 is composed of two pieces of joining equipment 43A and 43B, and the joining device 40 is provided with three moving units 45A to 45C. In addition, in the present embodiment, the joining equipment 43A includes an azimuth angle adjustment unit (yaw angle adjustment unit) 61A in addition to the above-described joining tool 46A. Additionally, the joining equipment 43B includes an azimuth angle adjustment unit (yaw angle adjustment unit) 61B in addition to the above-described joining tool 46B.

In the present embodiment, the joining equipment 43A joins each of the current collecting bundle portions (first current collecting bundle portions) 21 of both of the paired uncoated portions 11 (11A, 11B) to a corresponding one of the leads 31 for the electrode group 2 that was conveyed in by the moving unit 45A. Then, responding to the completion of the joining of the current collecting bundle portions 21 of the uncoated portions 11A and 11B, the moving unit 45B moves the electrode group 2 and the paired leads 31 from the joining equipment 43A to the joining equipment 43B.

Furthermore, in the present embodiment, the joining equipment 43B joins each of the current collecting bundle portions (second current collecting bundle portions) 22 of both of the paired uncoated portions 11 (11A, 11B) to a corresponding one of the leads 31 for the electrode group 2 that was conveyed in by the moving unit 45B. Then, responding to the completion of the joining of the current collecting bundle portions 22 of the uncoated portions 11A and 11B, the moving unit 45C moves the electrode group 2 and the paired leads 31 from the joining equipment 43B. Thereby, an electrode group assembly, in which each of the uncoated portions 11 is joined to the corresponding one of the leads 31, is conveyed out from the joining device 40.

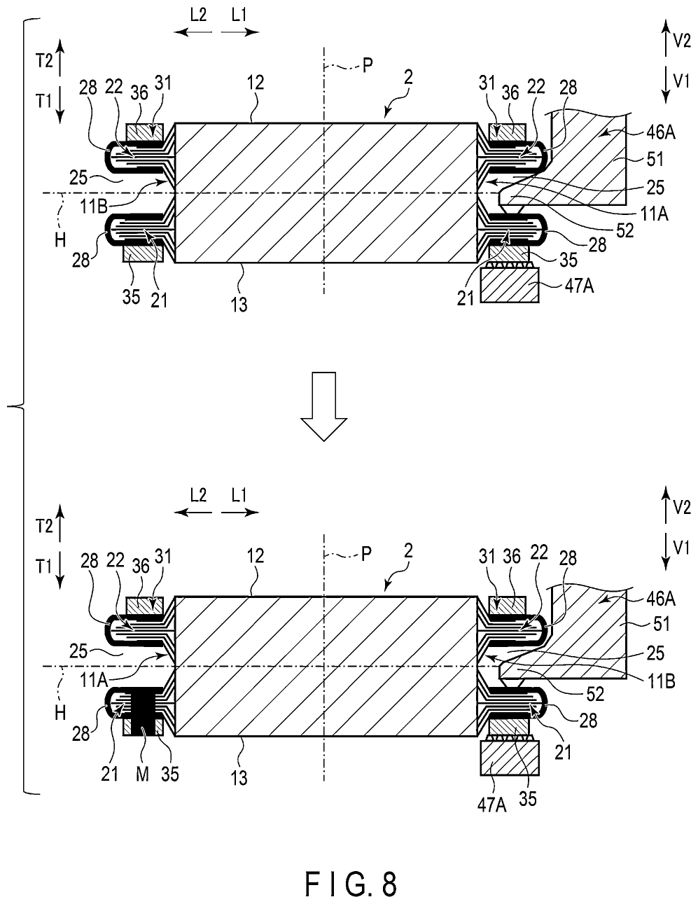

FIG. 8 is a diagram for describing a process performed by one piece of joining equipment 43A of the joining process unit 41. FIG. 8 schematically illustrates a state in which the current collecting bundle portion 21 of the uncoated portion 11A is being joined to the lead 31, and a state in which the current collecting bundle portion 21 of the uncoated portion 11B is being joined to the lead 31. In addition, FIG. 8 illustrates the electrode group 2 by a cross section perpendicular or substantially perpendicular to the width direction.

As illustrated in FIG. 8, in the present embodiment, similarly to the above-described embodiment or the like, in the joining equipment 43A, the current collecting bundle portion 21 of the uncoated portion 11A is joined to the lead 31 at the attitude at which the electrode group main surface (first electrode group main surface) 12 faces the vertically upper side and the electrode group main surface (second electrode group main surface) 13 faces the vertically lower side. In addition, the joining tip portion 52 of the joining tool 46A is inserted in the gap 25 between the current collecting bundle portions 21 and 22 of the uncoated portion 11A. Then, the current collecting bundle portion 21 is joined to the lead 31 by applying pressure to the current collecting bundle portion 21 from at least one side in the thickness direction, such as by applying pressure to the current collecting bundle portion 21 of the uncoated portion 11A from the joining tool 46A. Note that in FIG. 8, a joined portion M, in which the current collecting bundle portion 21 of the uncoated portion 11A was joined to the lead 31, is indicated by black coloring.

In addition, in the present embodiment, if the joining of the current collecting bundle portion 21 of the uncoated portion 11A ends, the azimuth angle adjustment unit 61A in the joining equipment 43A rotates the electrode group 2 around the axis P along the vertical direction. Thereby, from the attitude of the electrode group 2 during joining of the current collecting bundle portion 21 of the uncoated portion 11A, the angular position of the electrode group 2 around the axis P changes, and the azimuth angle (yaw angle) of the electrode group 2 changes. Then, the current collecting bundle portion 21 of the uncoated portion 11B is joined to the lead 31 in the state in which the azimuth angle of the electrode group 2 was changed from the attitude of the electrode group 2 during joining of the current collecting bundle portion 21 of the uncoated portion 11A. In the example of FIG. 8, the joining of the current collecting bundle portion 21 of the uncoated portion 11B is performed by rotating the electrode group 2 over 180° or approximately 180° around the axis P, from the attitude of the electrode group 2 during joining of the current collecting bundle portion 21 of the uncoated portion 11A.

However, also in the joining of the current collecting bundle portion 21 of the uncoated portion 11B to the lead 31, the state in which the electrode group main surface 12 faces the vertically upper side is maintained from the attitude of the electrode group 2 during joining of the current collecting bundle portion 21 of the uncoated portion 11A. Thus, in the joining of the current collecting bundle portion 21 of the uncoated portion 11B, the attitude angle (pitch angle and roll angle) of the electrode group 2 with respect to the horizontal plane H is maintained from the attitude of the electrode group 2 during joining of the current collecting bundle portion 21 of the uncoated portion 11A. In addition, in the present embodiment, the joining tip portion 52 of the joining tool 46A is inserted in the gap 25 between the current collecting bundle portions 21 and 22 of the uncoated portion 11B. Then, the current collecting bundle portion 21 is joined to the lead 31 by applying pressure to the current collecting bundle portion 21 from at least one side in the thickness direction, such as by applying pressure to the current collecting bundle portion 21 of the uncoated portion 11B from the joining tool 46A.

In the present embodiment, the moving unit 45B moves the electrode group 2, in which the current collecting bundle portions 21 of the uncoated portions 11A, 11B were joined, from the joining equipment 43A to the joining equipment 43B. At this time, the electrode group 2 is moved from the position where the joining was performed by the joining tool 46A to the position where joining is to be performed by the joining tool 46B, while the attitude angle of the electrode group 2 with respect to the horizontal plane H is maintained in the state in which the electrode group main surface (first electrode group main surface) 12 faces the vertically upper side.

In the joining equipment 43B, the joining of the current collecting bundle portions (second current collecting bundle portions) 22 of the uncoated portions 11A, 11B are performed while the attitude angle of the electrode group 2 with respect to the horizontal plane H is maintained in the state in which the electrode group main surface (first electrode group main surface) 12 faces the vertically upper side. In the joining of the current collecting bundle portion 22 of the uncoated portion 11A to the lead 31, the joining tip portion 52 of the joining tool 46B is inserted in the gap 25 between the current collecting bundle portions 21 and 22 of the uncoated portion 11A. Then, the current collecting bundle portion 22 is joined to the lead 31 by applying pressure to the current collecting bundle portion 22 from at least one side in the thickness direction, such as by applying pressure to the current collecting bundle portion 22 of the uncoated portion 11A from the joining tool 46B.

In addition, in the joining equipment 43B, if the joining of the current collecting bundle portion 22 of the uncoated portion 11A ends, the azimuth angle adjustment unit 61B rotates the electrode group 2 around the axis P along the vertical direction. Then, the current collecting bundle portion 22 of the uncoated portion 11B is joined to the lead 31 in the state in which the azimuth angle of the electrode group 2 was changed from the attitude of the electrode group 2 during the joining of the current collecting bundle portion 22 of the uncoated portion 11A. At this time, in one example, the joining of the current collecting bundle portion 22 of the uncoated portion 11B is performed by rotating the electrode group 2 over 180° or approximately 180° around the axis P, from the attitude of the electrode group 2 during the joining of the current collecting bundle portion 22 of the uncoated portion 11A.

However, also in the joining of the current collecting bundle portion 22 of the uncoated portion 11B to the lead 31, the state in which the electrode group main surface 12 faces the vertically upper side is maintained from the attitude of the electrode group 2 during the joining of the current collecting bundle portion 22 of the uncoated portion 11A. Thus, in the joining of the current collecting bundle portion 22 of the uncoated portion 11B, the attitude angle (pitch angle and roll angle) of the electrode group 2 with respect to the horizontal plane H is maintained from the attitude of the electrode group 2 during the joining of the current collecting bundle portion 22 of the uncoated portion 11A. In addition, in the present embodiment, the joining tip portion 52 of the joining tool 46B is inserted in the gap 25 between the current collecting bundle portions 21 and 22 of the uncoated portion 11B. Then, the current collecting bundle portion 22 is joined to the lead 31 by applying pressure to the current collecting bundle portion 22 from at least one side in the thickness direction, such as by applying pressure to the current collecting bundle portion 22 of the uncoated portion 11B from the joining tool 46B.

Also in the present embodiment, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the pieces of joining equipment 43A and 43B, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H.

Because of the above-described configuration, in the present embodiment, the same operation and advantageous effects as in the above-described embodiment can be obtained. Specifically, by using the joining device 40 of the present embodiment, the two current collecting bundle portions 21 and 22 arranged in the thickness direction in the electrode group 2 can appropriately be joined to the lead 31 without inverting the electrode group 2 in the vertical direction.

### Third Embodiment

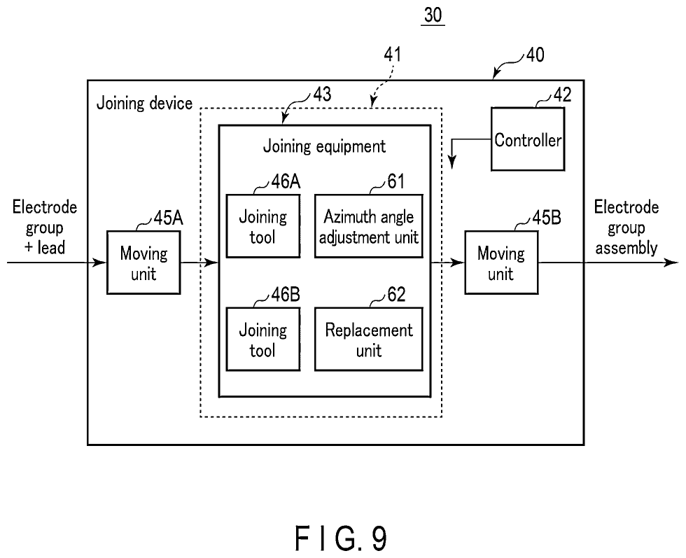

Next, as a modification of the first embodiment and second embodiment, a third embodiment is described. FIG. 9 schematically illustrates, by a block diagram, an example of a manufacturing system 30 of a battery 1 in the present embodiment. As illustrated in FIG. 9, also in the present embodiment, the joining device 40 of the manufacturing system 30 includes the joining process unit 41 and controller 42. However, in the present embodiment, the joining process unit 41 is composed of a single piece of joining equipment 43, and the joining device 40 is provided with two moving units 45A and 45B. In addition, in the present embodiment, the joining equipment 43 includes both of the above-described joining tools 46A and 46B. Specifically, the single piece of joining equipment 43 is provided with two joining tools 46A and 46B. Additionally, the joining equipment 43 includes a replacement unit 62 in addition to the azimuth angle adjustment unit (yaw angle adjustment unit) 61.

In the present embodiment, the joining equipment 43 joins each of the current collecting bundle portions 21 and 22 of both of the paired uncoated portions 11 (11A, 11B) to a corresponding one of the leads 31 for the electrode group 2 that was conveyed in by the moving unit 45A. Specifically, the joining of all of the four current collecting bundle portions 21 and 22 is performed by the single piece of joining equipment 43. In addition, responding to the completion of the joining of the four current collecting bundle portions 21 and 22, the moving unit 45B moves the electrode group 2 and the paired leads 31 from the joining equipment 43. Thereby, an electrode group assembly, in which each of the uncoated portions 11 is joined to the corresponding one of the leads 31, is conveyed out from the joining device 40.

In the joining equipment 43 of the present embodiment, the azimuth angle adjustment unit 61, like the azimuth angle adjustment units 61A and 61B of the second embodiment or the like, rotates the electrode group 2 around the axis P along the vertical direction. Thereby, in the present embodiment, similarly to the second embodiment or the like, each of the current collecting bundle portions 21 and 22 of the uncoated portion 11B is joined to the lead 31 in the state in which the azimuth angle of the electrode group 2 was changed from the attitude of the electrode group 2 during the joining of the current collecting bundle portions 21 and 22 of the uncoated portion 11A.

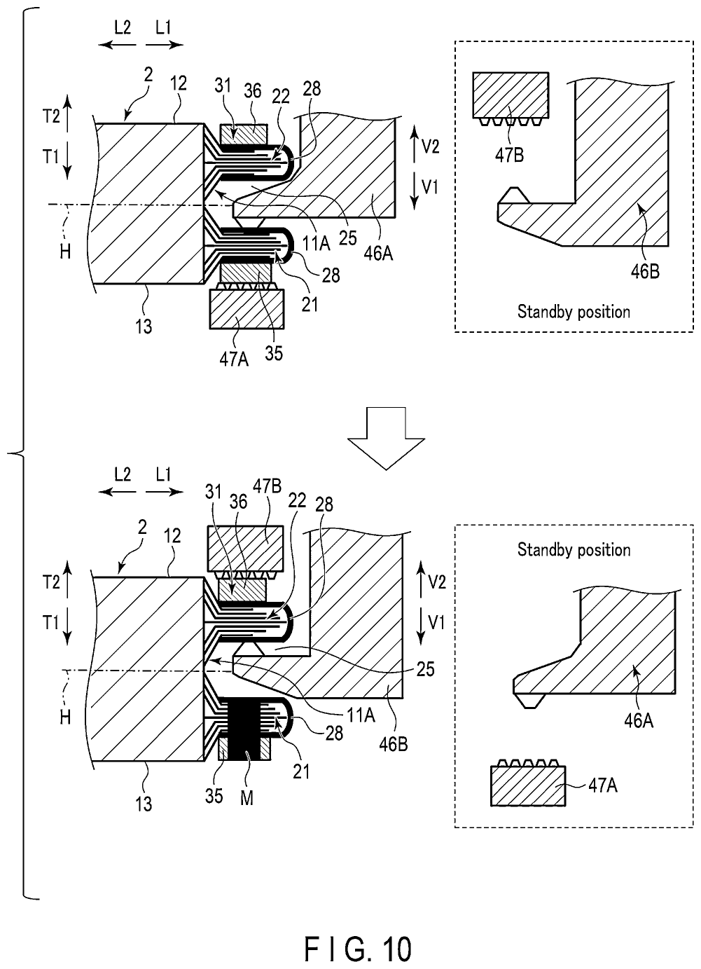

FIG. 10 is a diagram for describing the joining of the uncoated portion (first uncoated portion) 11A that is one of the paired uncoated portions 11 to the lead 31, the joining being performed by the joining process unit 41. FIG. 10 schematically illustrates a state in which the current collecting bundle portion 21 of the uncoated portion 11A is being joined to the lead 31, and a state in which the current collecting bundle portion 22 of the uncoated portion 11A is being joined to the lead 31. In addition, FIG. 10 illustrates the electrode group 2 by a cross section perpendicular or substantially perpendicular to the width direction.

As illustrated in FIG. 10, in the present embodiment, similarly to the above-described embodiment or the like, in the joining equipment 43, the current collecting bundle portion (first current collecting bundle portion) 21 of the uncoated portion 11A is joined to the lead 31 at the attitude at which the electrode group main surface (first electrode group main surface) 12 faces the vertically upper side. In addition, the current collecting bundle portion 21 is joined to the lead 31 by applying pressure to the current collecting bundle portion 21 from at least one side in the thickness direction of the electrode group 2, by using the joining tool (first joining tool) 46A. At this time, the current collecting bundle portion 21 is joined in the state in which the lead 31 and the current collecting bundle portion 21 of the uncoated portion 11A are clamped between the joining tool 46A and the stage 47A.

Note that in FIG. 10, a joined portion M, in which the current collecting bundle portion 21 of the uncoated portion 11A was joined to the lead 31, is indicated by black coloring. In addition, in the present embodiment, in the state in which the current collecting bundle portion 21 of the uncoated portion 11A is being joined by using the joining tool 46A, the joining tool (second joining tool) 46B and the stage 47B are placed in a standby position.

Furthermore, in the present embodiment, responding to the completion of the joining of the current collecting bundle portion 21 of the uncoated portion 11A, in the joining equipment 43, the replacement unit 62 replaces an insertion target, which is inserted in the gap 25 between the current collecting bundle portions 21 and 22 of the uncoated portion 11A, from the joining tool 46A to the joining tool 46B. In addition, the stage 47A used in the joining of the current collecting bundle portion 21 of the uncoated portion 11A is replaced with the stage 47B. By the replacement by the replacement unit 62, the state in which the joining tool 46B and the stage 47B are placed in the standby position transitions to the state in which the joining tool 46A and the stage 47A are placed in the standby position.

In addition, in the joining equipment 43, after the replacement or the like to the joining tool 46B by the replacement unit 62 has been performed, the joining of the current collecting bundle portion (second current collecting bundle portion) 22 of the uncoated portion 11A to the lead 31 is performed. Also in the present embodiment, in the joining of the current collecting bundle portion 22 of the uncoated portion 11A, the state in which the electrode group main surface 12 faces the vertically upper side is maintained from the attitude of the electrode group 2 during joining of the current collecting bundle portion 21 of the uncoated portion 11A. Thus, in the joining of the current collecting bundle portion 22 of the uncoated portion 11A, the attitude angle (pitch angle and roll angle) of the electrode group 2 with respect to the horizontal plane H is maintained from the attitude of the electrode group 2 during joining of the current collecting bundle portion 21 of the uncoated portion 11A. Also in the present embodiment, the current collecting bundle portion 22 is joined to the lead 31 by applying pressure to the current collecting bundle portion 22 from at least one side in the thickness direction of the electrode group 2, by using the joining tool (second joining tool) 46B.

Additionally, in the joining equipment 43, except that the azimuth angle of the electrode group 2 is changed from the joining of the uncoated portion 11A by the rotation about the axis P, the joining of the current collecting bundle portion 21, 22 of the uncoated portion 11B to the lead 31 is performed similarly to the joining of the current collecting bundle portion 21, 22 of the uncoated portion 11A. Specifically, in the state in which the joining tool 46B and stage 47B are placed in the standby position, the current collecting bundle portion 21 of the uncoated portion 11B is joined to the lead 31 by using the joining tool 46A and stage 47A. Then, responding to the completion of the joining of the current collecting bundle portion 21 of the uncoated portion 11B, the replacement unit 62 replaces the insertion target, which is inserted in the gap 25 between the current collecting bundle portions 21 and 22 of the uncoated portion 11B, from the joining tool 46A to the joining tool 46B. In addition, after the replacement or the like to the joining tool 46B by the replacement unit 62 has been performed, the current collecting bundle portion 22 of the uncoated portion 11B is joined to the lead 31 by using the joining tool 46B and stage 47B, in the state in which the joining tool 46A and stage 47A are placed in the standby position.

Also in the present embodiment, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the joining equipment 43, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H.

Because of the above-described configuration, in the present embodiment, the same operation and advantageous effects as in the above-described embodiments can be obtained. Specifically, by using the joining device 40 of the present embodiment, the two current collecting bundle portions 21 and 22 arranged in the thickness direction in the electrode group 2 can appropriately be joined to the lead 31, without inverting the electrode group 2 in the vertical direction.

### (Modifications of First Embodiment to Third Embodiment)

Note that in one modification of the third embodiment, the joining process unit 41 is composed of two pieces of joining equipment 43, namely joining equipment that performs joining of the uncoated portion 11A, and joining equipment that performs joining of the uncoated portion 11B. In addition, similarly to the third embodiment or the like, each of the two pieces of joining equipment includes two joining tools 46A and 46B, and a replacement unit 62. In the present modification, however, unlike the third embodiment or the like, each of the pieces of joining equipment 43 is not provided with the azimuth angle adjustment unit 61. Instead, in the present modification, a moving unit is provided which moves the electrode group 2 and the paired leads 31 from one of the two pieces of joining equipment 43 to the other.

In the present modification, the current collecting bundle portions 21, 22 of the uncoated portion 11A are joined in the same manner as in the third embodiment or the like. Specifically, in one of the two pieces of joining equipment 43, the current collecting bundle portion 21 of the uncoated portion 11A is joined to the lead 31 by using the joining tool 46A and stage 47A, in the state in which the joining tool 46B and stage 47B are placed in the standby position. Then, responding to the completion of the joining of the current collecting bundle portion 21 of the uncoated portion 11A, the replacement unit 62 replaces the insertion target, which is inserted in the gap 25 between the current collecting bundle portions 21 and 22 of the uncoated portion 11A, from the joining tool 46A to the joining tool 46B. In addition, after the replacement or the like to the joining tool 46B by the replacement unit 62 has been performed, the current collecting bundle portion 22 of the uncoated portion 11A is joined to the lead 31 by using the joining tool 46B and stage 47B, in the state in which the joining tool 46A and stage 47A are placed in the standby position.

In addition, in the present modification, responding to the completion of the joining of the current collecting bundle portions 21 and 22 of the uncoated portion 11A, the moving unit moves the electrode group 2 and the paired leads 31 from one of the two pieces of joining equipment 43 to the other. At this time, the electrode group 2 is moved while the attitude angle of the electrode group 2 with respect to the horizontal plane H is maintained in the state in which the electrode group main surface 12 faces the vertically upper side. Additionally, in the other of the two pieces of joining equipment 43, the current collecting bundle portions 21, 22 of the uncoated portion 11B are joined in the same manner as in the third embodiment or the like.

Also in the present modification, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the pieces of joining equipment 43, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H. Accordingly, also in the present modification, the same operation and advantageous effects as in the above-described embodiments or the like can be obtained.

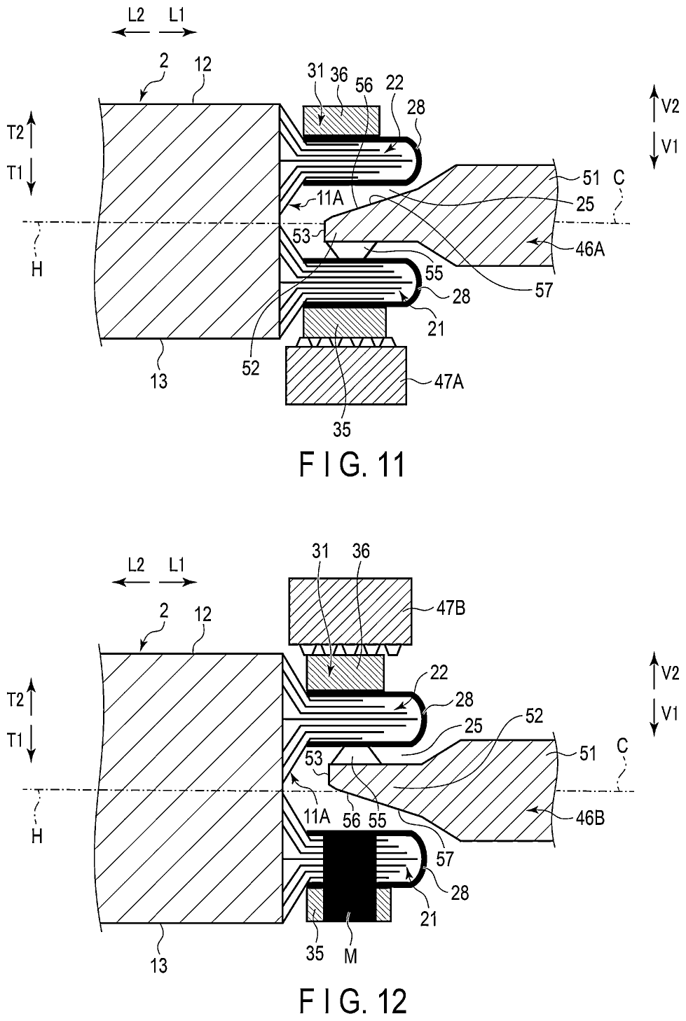

Additionally, in the above-described embodiments or the like, in each of the joining tools 46A and 46B, the joining tip portion 52 is bent with respect to the tool body 51, but the embodiments or the like are not limited to this. In one modification, as illustrated in FIG. 11 and FIG. 12, of the first to third embodiments, the joining tip portion 52 is not bent with respect to the tool body 51 in each of the joining tools 46A and 46B, and the joining tip portion 52 extends straight or substantially straight with respect to the tool body 51.

FIG. 11 illustrates a state in which the current collecting bundle portion (first current collecting bundle portion) 21, which is one of the two current collecting bundle portions 21 and 22, in the uncoated portion (first uncoated portion) 11A, which is one of the paired uncoated portions 11, is being joined by using the joining process unit 41. FIG. 12 illustrates a state in which the current collecting bundle portion (second current collecting bundle portion) 22, which is the other of the two current collecting bundle portions 21 and 22, in the uncoated portion (first uncoated portion) 11A, which is one of the paired uncoated portions 11, is being joined by using the joining process unit 41. In FIG. 11 and FIG. 12, the electrode group 2 is illustrated by a cross section perpendicular or substantially perpendicular to the width direction, and the uncoated portion 11A of the electrode group 2 and a vicinity thereof are illustrated. In addition, in FIG. 12, a joined portion M, in which the current collecting bundle portion 21 of the uncoated portion 11A was joined to the lead 31, is indicated by black coloring.

As illustrated in FIG. 11 and FIG. 12, also in the present modification, in each of the joining tools 46A and 46B, the tool body 51 extends along the center axis C, i.e., along the axial direction, from the proximal side toward the distal side. In addition, in each of the joining tools 46A and 46B, the joining tip portion 52 is connected to a distal portion of the tool body 51. In the present modification, however, in each of the joining tools 46A and 46B, the joining tip portion 52 extends along the center axis C of the tool body 51 from the proximal side to the distal side. Accordingly, in each of the joining tools 46A and 46B, the joining tip portion 52 is not bent with respect to the center axis C of the tool body 51. Also in the present modification, similarly to the above-described embodiments or the like, in each of the joining tools 46A and 46B, the joining tip portion 52 includes the distal surface 53, projection 55 and back surface 56, and the inclined surface 57 is formed on the back surface 56.

As illustrated in FIG. 11, also in the present modification, in a case where the current collecting bundle portion (first current collecting bundle portion) 21 is joined to the lead 31 in each of the uncoated portions 11, the joining tip portion 52 of the joining tool 46A or the like is inserted in the gap 25 at such an attitude that the projection 55 protrudes toward the current collecting bundle portion (first current collecting bundle portion) 21, and the back surface 56 faces the current collecting bundle portion (second current collecting bundle portion) 22. In the present modification, however, the joining tip portion 52 of the joining tool 46A or the like is inserted in the gap 25 in a state in which the axial direction (center axis C) of the tool body 51 is along the horizontal plane H.

As illustrated in FIG. 12, also in the present modification, in a case where the current collecting bundle portion (second current collecting bundle portion) 22 is joined to the lead 31 in each of the uncoated portions 11, the joining tip portion 52 of the joining tool 46B or the like is inserted in the gap 25 at such an attitude that the projection 55 protrudes toward the current collecting bundle portion (second current collecting bundle portion) 22, and the back surface 56 faces the current collecting bundle portion (first current collecting bundle portion) 21. In the present modification, however, the joining tip portion 52 of the joining tool 46B or the like is inserted in the gap 25 in a state in which the axial direction (center axis C) of the tool body 51 is along the horizontal plane H.

Also in the present modification, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the pieces of joining equipment 43, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H. Accordingly, also in the present modification, the same operation and advantageous effects as in the above-described embodiments or the like can be obtained.

### Fourth Embodiment

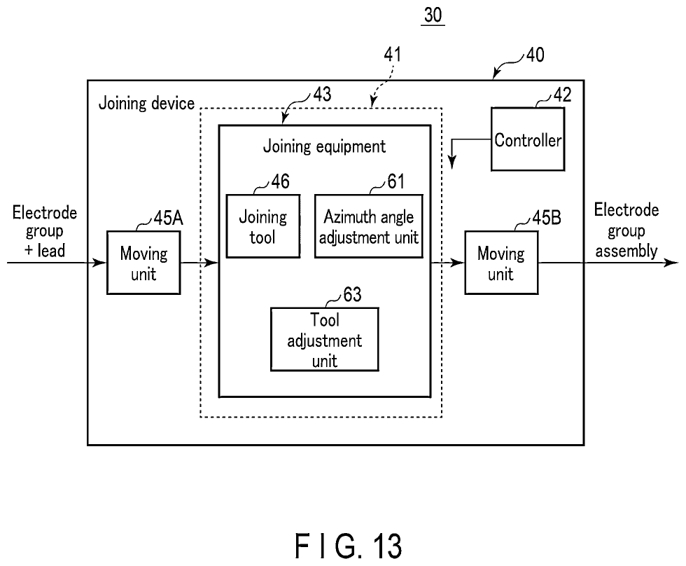

Next, as a modification of the first embodiment to the third embodiment, a fourth embodiment is described. FIG. 13 schematically illustrates, by a block diagram, an example of a manufacturing system 30 of a battery 1 in the present embodiment. As illustrated in FIG. 13, also in the present embodiment, the joining device 40 of the manufacturing system 30 includes the joining process unit 41 and controller 42. However, in the present embodiment, the joining process unit 41 is composed of a single piece of joining equipment 43, and the joining device 40 is provided with two moving units 45A and 45B. In addition, in the present embodiment, the joining equipment 43 includes only one joining tool 46. In addition, the joining equipment 43 includes a tool adjustment unit 63 in addition to the azimuth angle adjustment unit (yaw angle adjustment unit) 61.

In the present embodiment, similarly to the third embodiment or the like, the joining equipment 43 joins each of the current collecting bundle portions 21 and 22 of both of the paired uncoated portions 11 (11A, 11B) to a corresponding one of the leads 31 for the electrode group 2 that was conveyed in by the moving unit 45A. In addition, in the present embodiment, a single joining tool 46 is shared for the joining of the current collecting bundle portions 21 and 22 of both of the paired uncoated portions 11 (11A, 11B), i.e., for the joining of all of the four current collecting bundle portions 21 and 22. In addition, responding to the completion of the joining of the four current collecting bundle portions 21 and 22, the moving unit 45B moves the electrode group 2 and the paired leads 31 from the joining equipment 43. Thereby, an electrode group assembly, in which each of the uncoated portions 11 is joined to the corresponding one of the leads 31, is conveyed out from the joining device 40.

In the joining equipment 43 of the present embodiment, the azimuth angle adjustment unit 61, similarly to the azimuth angle adjustment units 61A and 61B of the second embodiment or the like, rotates the electrode group 2 about the axis P along the vertical direction. Thereby, also in the present embodiment, similarly to the second embodiment or the like, each of the current collecting bundle portions 21 and 22 of the uncoated portion 11B is joined to the lead 31 in the state in which the azimuth angle of the electrode group 2 is changed from the attitude of the electrode group 2 during the joining of the current collecting bundle portions 21 and 22 of the uncoated portion 11A.

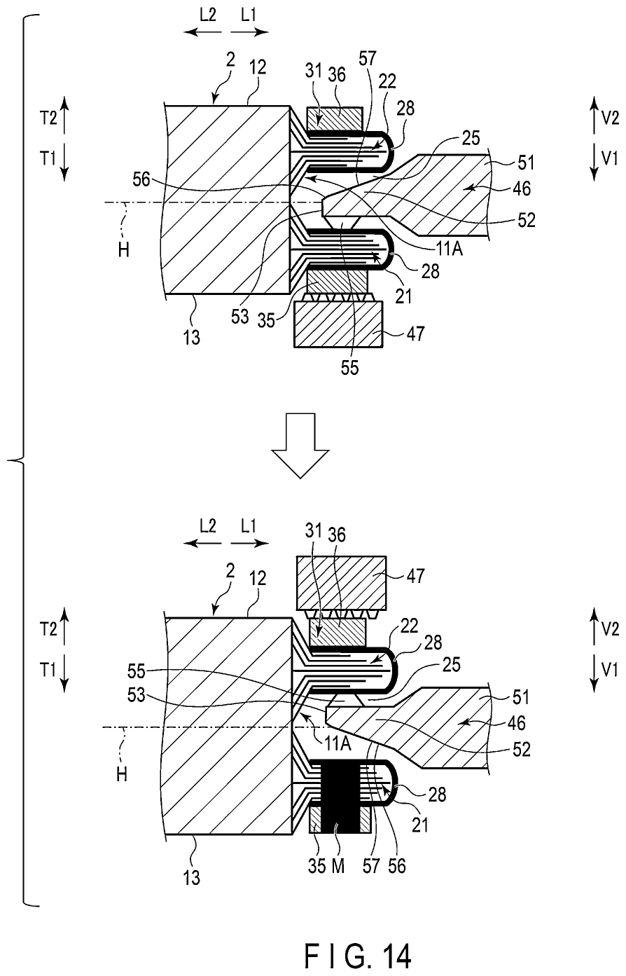

FIG. 14 is a diagram for describing the joining of the uncoated portion (first uncoated portion) 11A that is one of the paired uncoated portions 11 to the lead 31, the joining being performed by the joining process unit 41. FIG. 14 schematically illustrates a state in which the current collecting bundle portion 21 of the uncoated portion 11A is being joined to the lead 31, and a state in which the current collecting bundle portion 22 of the uncoated portion 11A is being joined to the lead 31. In addition, FIG. 14 illustrates the electrode group 2 by a cross section perpendicular or substantially perpendicular to the width direction.

As illustrated in FIG. 14 or the like, the joining tool 46, similarly to the joining tools 46A and 46B of the above-described embodiments or the like, includes a tool body 51 and a joining tip portion 52. In addition, in the joining tool 46, like the joining tools 46A and 46B, the joining tip portion 52 includes a distal surface 53, a projection 55 and a back surface 56, and an inclined surface 57 is formed on the back surface 56. Further, in the example of FIG. 14, one stage 47 is shared for the joining of the current collecting bundle portions 21 and 22 of both of the paired uncoated portions 11 (11A, 11B), i.e., for the joining of all of the four current collecting bundle portions 21 and 22. However, in one example, four stages are provided, and the different stages are used in the joining of the four current collecting bundle portions 21 and 22. In another example, two stages are provided. One of the two stages is shared for the joining of the current collecting bundle portions 21 of the paired uncoated portions (11A, 11B), and the other of the two stages is shared for the joining of the current collecting bundle portions 22 of the paired uncoated portions (11A, 11B).

Also in the present embodiment, similarly to the above-described embodiments or the like, in the joining equipment 43, the current collecting bundle portion (first current collecting bundle portion) 21 of the uncoated portion 11A is joined to the lead 31 at the attitude at which the electrode group main surface (first electrode group main surface) 12 faces the vertically upper side. At this time, in the present embodiment, the joining tool 46 is inserted in the gap 25 between the current collecting bundle portions 21 and 22 of the uncoated portion 11A. Then, the current collecting bundle portion 21 is joined to the lead 31 by applying pressure to the current collecting bundle portion 21 from at least one side in the thickness direction, such as by applying pressure to the current collecting bundle portion 21 of the uncoated portion 11A from the joining tool 46 inserted in the gap 25.

Additionally, in the joining of the current collecting bundle portion 21 of the uncoated portion 11A, the joining tip portion 52 of the joining tool 46 is inserted in the gap 25 from the distal end (distal surface 53) at such an attitude that the projection 55 protrudes toward the current collecting bundle portion 21, and the back surface 56 faces the current collecting bundle portion 22. Note that in FIG. 14, a joined portion M, in which the current collecting bundle portion 21 of the uncoated portion 11A was joined to the lead 31, is indicated by black coloring.

Additionally, in the present embodiment, responding to the completion of the joining of the current collecting bundle portion 21 of the uncoated portion 11A, in the joining equipment 43, the tool adjustment unit 63 inverts the joining tool 46 in the thickness direction of the electrode group 2 from the attitude of the joining tool 46 during joining of the current collecting bundle portion 21 of the uncoated portion 11A. In the example of FIG. 14, responding to the completion of the joining of the current collecting bundle portion 21 of the uncoated portion 11A, the joining tool 46 is inverted in the vertical direction from the attitude of the joining tool 46 during joining of the current collecting bundle portion 21 of the uncoated portion 11A.

In the present embodiment, the joining tool 46 is inserted in the gap 25 between the current collecting bundle portions 21 and 22 of the uncoated portion 11A in the state in which the joining tool 46 is inverted in the thickness direction of the electrode group 2 from the attitude of the joining tool 46 during joining of the current collecting bundle portion 21 of the uncoated portion 11A. In addition, the current collecting bundle portion 22 is joined to the lead 31 by applying pressure to the current collecting bundle portion 22 from at least one side in the thickness direction, such as by applying pressure to the current collecting bundle portion 22 of the uncoated portion 11A from the joining tool 46 inserted in the gap 25. Further, in the joining of the current collecting bundle portion 22 of the uncoated portion 11A, the joining tip portion 52 of the joining tool 46 is inserted in the gap 25 from the distal end (distal surface 53) at such an attitude that the projection 55 protrudes toward the current collecting bundle portion 22, and the back surface 56 faces the current collecting bundle portion 21.

Also in the present embodiment, in the joining of the current collecting bundle portion 22 of the uncoated portion 11A, the state in which the electrode group main surface 12 faces the vertically upper side is maintained from the attitude of the electrode group 2 during joining of the current collecting bundle portion 21 of the uncoated portion 11A. Thus, in the joining of the current collecting bundle portion 22 of the uncoated portion 11A, the attitude angle (pitch angle and roll angle) of the electrode group 2 with respect to the horizontal plane H is maintained from the attitude of the electrode group 2 during joining of the current collecting bundle portion 21 of the uncoated portion 11A.

In addition, in the joining equipment 43, except that the azimuth angle of the electrode group 2 is changed from the joining of the uncoated portion 11A by the rotation about the axis P, the joining of the current collecting bundle portions 21, 22 of the uncoated portion 11B to the lead 31 is performed similarly to the joining of the current collecting bundle portions 21, 22 of the uncoated portion 11A. Specifically, using the joining tool 46, the current collecting bundle portion 21 of the uncoated portion 11B is joined to the lead 31, and, responding to the completion of the joining of the current collecting bundle portion 21 of the uncoated portion 11B, the tool adjustment unit 63 inverts the joining tool 46 in the thickness direction of the electrode group 2 from the attitude of the joining tool 46 during joining of the current collecting bundle portion 21 of the uncoated portion 11B. In addition, the current collecting bundle portion 22 of the uncoated portion 11B is joined to the lead 31 in the state in which the joining tool 46 is inverted in the thickness direction of the electrode group 2 from the attitude of the joining tool 46 during joining of the current collecting bundle portion 21 of the uncoated portion 11B.

Also in the present embodiment, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the joining equipment 43, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H.

Because of the above-described configuration, also in the present embodiment, the same operation and advantageous effects as in the above-described embodiments can be obtained. Specifically, by using the joining device 40 of the present embodiment, the two current collecting bundle portions 21 and 22 arranged in the thickness direction in the electrode group 2 can appropriately be joined to the lead 31, without inverting the electrode group 2 in the vertical direction.

Additionally, in the present embodiment, in the joining tool 46, the above-described inclined surface 57 is formed on the back surface 56 of the joining tip portion 52. In addition, in a case where the current collecting bundle portion (first current collecting bundle portion) 21 is joined to the lead 31 in each of the uncoated portions 11, the joining tip portion 52 of the joining tool 46 is inserted in the gap 25 at the attitude at which the back surface 56 faces the current collecting bundle portion (second current collecting bundle portion) 22. Thereby, in the joining of the current collecting bundle portion 21 to the lead 31, the joining tool 46 is appropriately prevented from abutting on the current collecting bundle portion 22 and the clip 28 that is attached to the current collecting bundle portion 22.

Additionally, in the present embodiment, in a case where the current collecting bundle portion (second current collecting bundle portion) 22 is joined to the lead 31 in each of the uncoated portions 11, the joining tip portion 52 of the joining tool 46 is inserted in the gap 25 at the attitude at which the back surface 56 including the inclined surface 57 faces the current collecting bundle portion (first current collecting bundle portion) 21. Thereby, in the joining of the current collecting bundle portion 22 to the lead 31, the joining tool 46 is appropriately prevented from abutting on the current collecting bundle portion 21 and the clip 28 that is attached to the current collecting bundle portion 21.

Additionally, in the present embodiment, in the joining tip portion 52 of the joining tool 46, a projection or the like is not provided on the back surface 56 that faces an opposite side to the side on which the projection 55 protrudes. Thus, in the joining tip portion 52 of the joining tool 46, the dimension of that part of the joining tip portion 52 in the thickness direction thereof, which excludes the projection 55, is secured to a certain magnitude. Thereby, the rigidity of the joining tip portion 52 of the joining tool 46 is appropriately secured. Additionally, in the joining tip portion 52 of the joining tool 46, since a projection or the like is not provided on the back surface 56, the joining tip portion 52 can more easily be inserted in the gap 25 between the current collecting bundle portions 21 and 22.

### (Modification of Fourth Embodiment)

Note that in one modification of the fourth embodiment, the joining process unit 41 is composed of two pieces of joining equipment 43, namely joining equipment that performs joining of the uncoated portion 11A, and joining equipment that performs joining of the uncoated portion 11B. In addition, similarly to the fourth embodiment or the like, each of the two pieces of joining equipment includes a joining tool 46 that is shared for the joining of the two current collecting bundle portions 21 and 22, and a tool adjustment unit 63. In the present modification, however, unlike the fourth embodiment or the like, each of the pieces of joining equipment 43 is not provided with the azimuth angle adjustment unit 61. Instead, in the present modification, a moving unit is provided which moves the electrode group 2 and the paired leads 31 from one of the two pieces of joining equipment 43 to the other.

In the present embodiment, the current collecting bundle portions 21, 22 of the uncoated portion 11A is joined in the same manner as in the fourth embodiment or the like. Specifically, in one of the two pieces of joining equipment 43, the current collecting bundle portion 21 of the uncoated portion 11A is joined to the lead 31 by using the commonly used joining tool 46, and, responding to the completion of the joining of the current collecting bundle portion 21 of the uncoated portion 11A, the tool adjustment unit 63 inverts the joining tool 46 in the thickness direction of the electrode group 2 from the attitude of the joining tool 46 during joining of the current collecting bundle portion 21 of the uncoated portion 11A. In addition, the current collecting bundle portion 22 of the uncoated portion 11A is joined to the lead 31 in the state in which the joining tool 46 is inverted in the thickness direction of the electrode group 2 from the attitude of the joining tool 46 during joining of the current collecting bundle portion 21 of the uncoated portion 11A.

In addition, in the present modification, responding to the completion of the joining of the current collecting bundle portions 21 and 22 of the uncoated portion 11A, the moving unit moves the electrode group 2 and the paired leads 31 from one of the two pieces of joining equipment 43 to the other. At this time, the electrode group 2 is moved while the attitude angle of the electrode group 2 with respect to the horizontal plane H is maintained in the state in which the electrode group main surface 12 faces the vertically upper side. Additionally, in the other of the two pieces of joining equipment 43, the current collecting bundle portion 21, 22 of the uncoated portion 11B is joined in the same manner as in the fourth embodiment or the like.

Also in the present modification, the joining of each of the four (two pairs of) current collecting bundle portions 21 and 22 to the lead 31 is performed at such an attitude of the electrode group 2 that the electrode group main surface 12 faces the vertically upper side. Specifically, while the joining of the four current collecting bundle portions 21 and 22 is being performed by the joining process unit 41 including the pieces of joining equipment 43, the attitude angle (pitch angle and roll angle) of the electrode group 2 with respect to the horizontal plane H is maintained in the state in which the electrode group main surface 12 faces the vertically upper side. Thus, while the joining of the four current collecting bundle portions 21 and 22 is being performed, the electrode group 2 does not rotate around the axis crossing the vertical direction, and, for example, the electrode group 2 does not rotate around the axis along the horizontal plane H. Accordingly, also in the present modification, the same operation and advantageous effects as in the above-described embodiments or the like can be obtained.

### Fifth Embodiment

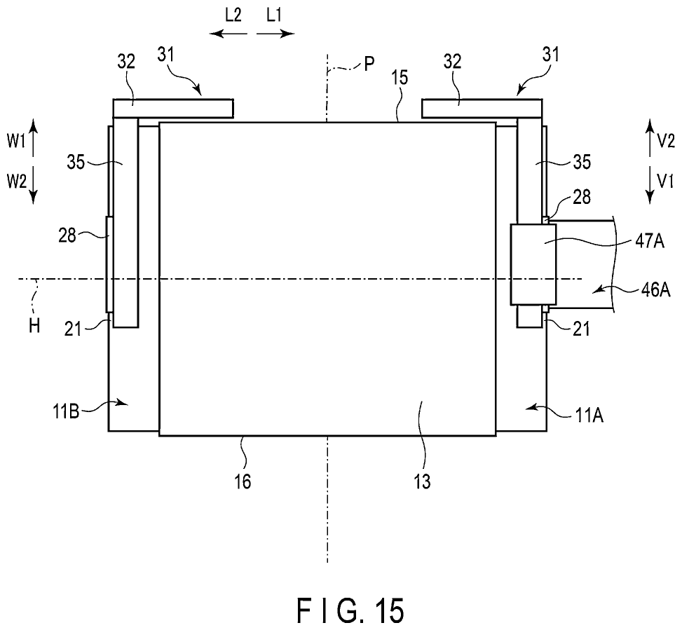

Next, as a modification of the above-described embodiments or the like, a fifth embodiment is described. FIG. 15 illustrates a state in which, in the present embodiment, the uncoated portion (first uncoated portion) 11A that is one of the paired uncoated portions 11 is being joined to the lead 31. FIG. 15 illustrates a state as viewed from one side in the thickness direction of the electrode group 2. As illustrated in FIG. 15, in the present embodiment, unlike the above-described embodiments or the like, in the joining process unit 41 of the joining device 40, the joining of the current collecting bundle portions 21, 22 of the uncoated portion 11A is performed in a state in which the length direction and thickness direction of the electrode group 2 are along the horizontal plane H, and the width direction of the electrode group 2 is along the vertical direction. In addition, the joining of the uncoated portion 11A to the lead 31 is performed at such an attitude that the electrode group edge surface (first electrode group edge surface) 15 faces the vertically upper side, and the electrode group edge surface (second electrode group edge surface) 16 faces the vertically lower side.

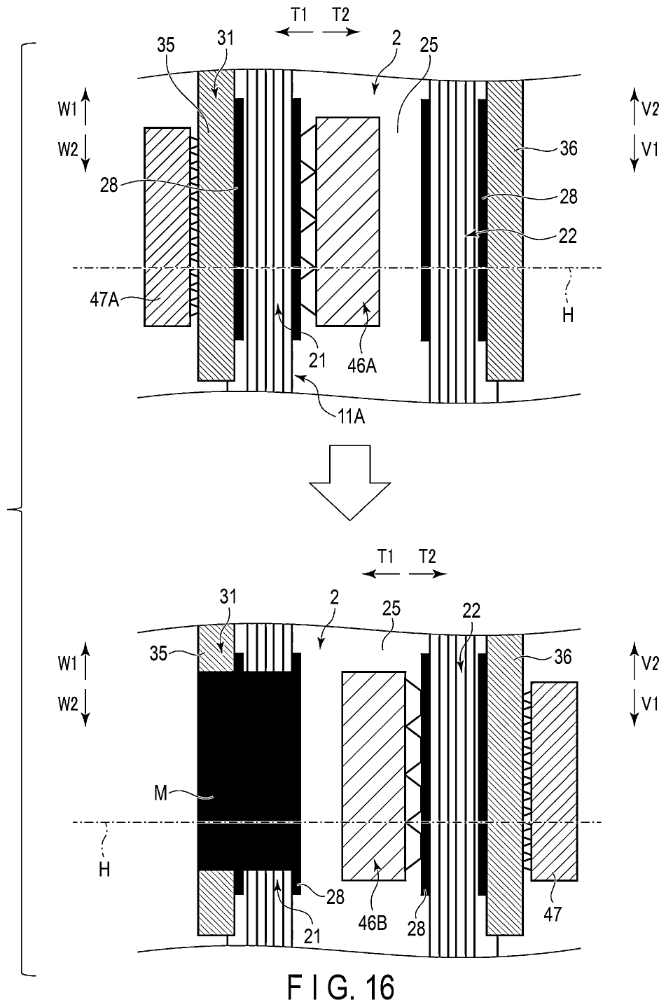

FIG. 16 is a diagram for describing the joining of the uncoated portion (first uncoated portion) 11A that is one of the paired uncoated portions 11 to the lead 31, the joining being performed by the joining process unit 41. FIG. 16 schematically illustrates a state in which the current collecting bundle portion 21 of the uncoated portion 11A is being joined to the lead 31, and a state in which the current collecting bundle portion 22 of the uncoated portion 11A is being joined to the lead 31. In addition, FIG. 16 illustrates the electrode group 2 by a cross section perpendicular or substantially perpendicular to the length direction.

As illustrated in FIG. 16, in the present embodiment, the current collecting bundle portion (first current collecting bundle portion) 21 of the uncoated portion 11A is joined to the lead 31 at such an attitude of the electrode group 2 that the electrode group edge surface (first electrode group edge surface) 15 faces the vertically upper side. In addition, the current collecting bundle portion 21 is joined to the lead 31 by applying pressure to the current collecting bundle portion 21 from at least one side in the thickness direction of the electrode group 2 by using the joining tool (first joining tool) 46A. At this time, unlike the above-described embodiments or the like, pressure is applied to the current collecting bundle portion 21 from the joining tool 46A or the like toward a direction along the horizontal plane H. Note that in FIG. 16, a joined portion M, in which the current collecting bundle portion 21 of the uncoated portion 11A was joined to the lead 31, is indicated by black coloring.

In addition, responding to the completion of the joining of the current collecting bundle portion 21 of the uncoated portion 11A, the current collecting bundle portion (second current collecting bundle portion) 22 of the uncoated portion 11A is joined to the lead 31 by using the joining tool (second joining tool) 46B. At this time, the current collecting bundle portion 22 is joined to the lead 31 by applying pressure to the current collecting bundle portion 22 from at least one side in the thickness direction of the electrode group 2 by using the joining tool 46B. In the present embodiment, unlike the above-described embodiments or the like, pressure is applied to the current collecting bundle portion 22 from the joining tool 46B or the like toward a direction along the horizontal plane H.

In the present embodiment, in the joining of the current collecting bundle portion 22 of the uncoated portion 11A, the state in which the electrode group edge surface 15 faces the vertically upper side is maintained from the attitude of the electrode group 2 during joining of the current collecting bundle portion 21 of the uncoated portion 11A. Specifically, in the joining of the current collecting bundle portion (second current collecting bundle portion) 22 of the uncoated portion 11A to the lead 31, while the state in which the electrode group edge surface (first electrode group edge surface) 15 faces the vertically upper side is maintained from the attitude of the electrode group 2 in the joining of the current collecting bundle portion (first current collecting bundle portion) 21 to the lead 31, the joining process unit 41 applies pressure to the current collecting bundle portion 22 from at least one side in the thickness direction of the electrode group 2. Thus, also in the present embodiment, in the joining of the current collecting bundle portion 22 of the uncoated portion 11A, the attitude angle (pitch angle and roll angle) of the electrode group 2 with respect to the horizontal plane H is maintained from the attitude of the electrode group 2 during joining of the current collecting bundle portion 21 of the uncoated portion 11A.

Here, in one example, similarly to the first embodiment and second embodiment, or the like, the electrode group 2 and the leads 31 are moved by a moving unit from the position where the current collecting bundle portion 21 of the uncoated portion 11A was joined to the position where current collecting bundle portion 22 of the uncoated portion 11A is to be joined. In this case, the moving unit moves the electrode group 2, while maintaining the attitude angle of the electrode group 2 with respect to the horizontal plane H from the attitude of the electrode group 2 during joining of the current collecting bundle portion 21 of the uncoated portion 11A to the lead 31. In another example, similarly to the third embodiment or the like, the joining equipment that joins the current collecting bundle portions 21, 22 of the uncoated portion 11A is provided with a replacement unit that replaces an insertion target, which is inserted in the gap 25, from the joining tool 46A to the joining tool 46B.

Additionally, in the present embodiment, while the state in which the electrode group edge surface (first electrode group edge surface) 15 faces the vertically upper side is maintained from the attitude of the electrode group 2 in the joining of the uncoated portion 11A to the lead 31, the joining process unit 41 joins each of the current collecting bundle portions 21 and 22 of the uncoated portion 11B to the lead 31. In one example, similarly to the first embodiment or the like, joining equipment that performs the joining of the uncoated portion 11B is provided separately from the joining equipment that performs the joining of the uncoated portion 11A. In addition, the moving unit moves the electrode group 2 and the leads 31 from the joining equipment that performs the joining of the uncoated portion 11A to the joining equipment that performs the joining of the uncoated portion 11B.

Additionally, in another example, similarly to the third embodiment or the like, the joining equipment is provided with an azimuth angle adjustment unit. Further, in the joining of the uncoated portion 11B, the azimuth angle (yaw angle) of the electrode group 2 is varied by the azimuth angle adjustment unit from the attitude of the electrode group 2 in the joining of the uncoated portion 11A, for example, by rotating the electrode group 2 around the axis P along the vertical direction. In each of the cases, however, in the joining of the uncoated portion 11B to the lead 31, the state in which the electrode group edge surface 15 faces the vertically upper side is maintained from the attitude of the electrode group 2 in the joining of the uncoated portion 11A. Specifically, the attitude angle (pitch angle and roll angle) of the electrode group 2 with respect to the horizontal plane H is maintained from the attitude of the electrode group 2 in the joining of the uncoated portion 11A.

As described above, in the present embodiment, the joining of each of the four (two pairs of) current collecting bundle portions 21 and 22 to the lead 31 is performed at such an attitude of the electrode group 2 that the electrode group edge surface 15 faces the vertically upper side. Specifically, while the joining of the four current collecting bundle portions 21 and 22 is being performed by the joining process unit 41, the attitude angle (pitch angle and roll angle) of the electrode group 2 with respect to the horizontal plane H is maintained in the state in which the electrode group edge surface 15 faces the vertically upper side. Thus, in the present embodiment, similarly to the above-described embodiments or the like, while the joining of the four current collecting bundle portions 21 and 22 is being performed, the electrode group 2 does not rotate around the axis crossing the vertical direction, and, for example, the electrode group 2 does not rotate around the axis along the horizontal plane H.

Because of the above-described configuration, in the present embodiment, the same operation and advantageous effects as in the above-described embodiments can be obtained. Specifically, by using the joining device 40 of the present embodiment, the two current collecting bundle portions 21 and 22 arranged in the thickness direction in the electrode group 2 can be appropriately joined to the lead 31, without inverting the electrode group 2 in the vertical direction.

Additionally, in the present embodiment, in the joining of the current collecting bundle portion 21 to the lead 31, pressure toward a direction along the horizontal plane H is applied to the current collecting bundle portion 21, and in the joining of the current collecting bundle portion 22 to the lead 31, pressure toward a direction along the horizontal plane H is applied to the current collecting bundle portion 22. Thus, in the present embodiment, the influence of gravitation in the application of the pressure to the current collecting bundle portion 22 becomes substantially equal to the influence of gravitation in the application of the pressure to the current collecting bundle portion 21. Thereby, a variance or the like in the degree of joining between the current collecting bundle portions 21 and 22 can easily be suppressed.

### (Modification of Fifth Embodiment)

Note that in the fifth embodiment, the joining tool 46B used for joining the current collecting bundle portion 22 is different from the joining tool 46A used for joining the current collecting bundle portion 21, but the fifth embodiment is not limited to this. In one modification, similarly to the fifth embodiment or the like, while the state in which the electrode group edge surface 15 faces the vertically upper side is maintained, the joining of the current collecting bundle portions 21 and 22 is performed, and, similarly to the fourth embodiment or the like, one joining tool 46 is shared for the joining of the current collecting bundle portions 21 and 22. In this case, similarly to the fourth embodiment or the like, the joining equipment is provided with a tool adjustment unit. In addition, in the joining of the current collecting bundle portion 22, the tool adjustment unit inverts the joining tool 46 in the thickness direction of the electrode group 2 from the attitude of the joining tool 46 during joining of the current collecting bundle portion 21, and the joining tool 46 is inserted in the gap 25. Also in the present modification, the same operation and advantageous effects as in the fifth embodiment or the like can be obtained.

### (Other Modifications)

Additionally, the above-described joining process of the current collecting bundle portions 21 and 22 is applicable to any configuration in which two current collecting bundle portions 21 and 22 are arranged in the thickness direction of the electrode group 2, with the gap 25 being interposed, in at least one of the paired uncoated portions 11 of the electrode group 2. Specifically, the joining process of the current collecting bundle portions 21 and 22 in the above-described embodiments or the like is applicable to even a configuration in which the negative electrode uncoated portion protrudes to the side on which the positive electrode uncoated portion protrudes in the electrode group 2, and a configuration in which the two current collecting bundle portions 21 and 22 are arranged in the thickness direction of the electrode group 2 in only one of the paired uncoated portions 11. In each of the cases, however, the current collecting bundle portion (second current collecting bundle portion) 22 is joined to the lead 31, while the attitude angle of the electrode group 2 with respect to the horizontal plane H is maintained from the attitude of the electrode group 2 in the joining of the current collecting bundle portion (first current collecting bundle portion) 21 to the lead 31.

According to at least one of these embodiments or the examples, the first current collecting bundle portion is joined to the lead by applying pressure to the first current collecting bundle portion from at least one side in the thickness direction for the electrode group in which the first current collecting bundle portion and the second current collecting bundle portion are arranged in the thickness direction with the gap being interposed. In addition, the second current collecting bundle portion is joined to the lead by applying pressure to the second current collecting bundle portion from at least one side in the thickness direction for the electrode group, and the second current collecting bundle portion is joined while the attitude angle of the electrode group with respect to the horizontal plane is maintained from the attitude of the electrode group during joining of the first current collecting bundle portion to the lead.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A joining device comprising a controller configured to control an operation of the joining device so as to:
join, for an electrode group in which a first current collecting bundle portion and a second current collecting bundle portion are arranged in a thickness direction with a gap being interposed, the first current collecting bundle portion to a lead by applying pressure to the first current collecting bundle portion from at least one side in the thickness direction; and
join, for the electrode group, the second current collecting bundle portion to the lead by applying pressure to the second current collecting bundle portion from at least one side in the thickness direction, the second current collecting bundle portion being joined while an attitude angle of the electrode group with respect to a horizontal plane is maintained from an attitude of the electrode group during joining of the first current collecting bundle portion to the lead.

2. The joining device of claim 1, wherein the controller is configured to control the operation of the joining device so as to:
join each of the first current collecting bundle portion and the second current collecting bundle portion to the lead for the electrode group including a first electrode group main surface and a second electrode group main surface that face mutually opposite sides in the thickness direction, the first current collecting bundle portion and the second current collecting bundle portion of the electrode group protruding in a length direction crossing the thickness direction;
apply, in the joining of the first current collecting bundle portion to the lead, the pressure to the first current collecting bundle portion from at least one side in the thickness direction, at such an attitude of the electrode group that the first electrode group main surface faces a vertically upper side; and
apply, in the joining of the second current collecting bundle portion to the lead, the pressure to the second current collecting bundle portion from at least one side in the thickness direction, while a state in which the first electrode group main surface faces the vertically upper side is maintained from the attitude of the electrode group during joining of the first current collecting bundle portion to the lead.

3. The joining device of claim 1, wherein the controller is configured to control the operation of the joining device so as to:
join each of the first current collecting bundle portion and the second current collecting bundle portion to the lead for the electrode group including a first electrode group main surface and a second electrode group main surface that face mutually opposite sides in the thickness direction, the first current collecting bundle portion and the second current collecting bundle portion of the electrode group protruding in a length direction crossing the thickness direction, and the electrode group including a first electrode group edge surface and a second electrode group edge surface facing mutually opposite sides in a width direction crossing both the thickness direction and the length direction;
apply, in the joining of the first current collecting bundle portion to the lead, the pressure to the first current collecting bundle portion from at least one side in the thickness direction, at such an attitude of the electrode group that the first electrode group edge surface faces a vertically upper side; and
apply, in the joining of the second current collecting bundle portion to the lead, the pressure to the second current collecting bundle portion from at least one side in the thickness direction, while a state in which the first electrode group edge surface faces the vertically upper side is maintained from the attitude of the electrode group during joining of the first current collecting bundle portion to the lead.

4. The joining device of claim 1, further comprising:
a first joining tool; and
a second joining tool that is different from the first joining tool,
wherein the controller is configured to control the operation of the joining device so as to:
insert, in the joining of the first current collecting bundle portion to the lead, the first joining tool into the gap, thereby applying the pressure to the first current collecting bundle portion in a state in which the first joining tool is inserted in the gap; and
insert, in the joining of the second current collecting bundle portion to the lead, the second joining tool into the gap, thereby applying the pressure to the second current collecting bundle portion in a state in which the second joining tool is inserted in the gap.

5. The joining device of claim 4, wherein the controller is configured to control the operation of the joining device so as to:
move the electrode group from a position where the joining was performed by the first joining tool to a position where joining is to be performed by the second joining tool, responding to a completion of the joining of the first current collecting bundle portion to the lead; and
move the electrode group, while the attitude angle of the electrode group with respect to the horizontal plane is maintained from the attitude of the electrode group during joining of the first current collecting bundle portion to the lead.

6. The joining device of claim 4, wherein the controller is configured to control the operation of the joining device so as to: replace an insertion target that is inserted in the gap between the first current collecting bundle portion and the second current collecting bundle portion, from the first joining tool to the second joining tool, responding to a completion of the joining of the first current collecting bundle portion to the lead.

7. The joining device of claim 4, wherein
each of the first joining tool and the second joining tool includes a joining tip portion,
an outer surface of the joining tip portion of each of the first joining tool and the second joining tool including a distal surface that forms a distal end of the joining tip portion, a projection that protrudes to one side in a thickness direction of the joining tip portion, the thickness direction crossing a distal direction of the joining tip portion, and a back surface that faces an opposite side to a side on which the projection protrudes in the thickness direction of the joining tip portion,
the back surface of the joining tip portion of each of the first joining tool and the second joining tool includes an inclined surface that is inclined with respect to the distal direction in a state in which the inclined surface extends closer to the side on which the projection protrudes in the thickness direction of the joining tip portion, as the inclined surface extends closer to the distal end of the joining tip portion, and
the controller is configured to control the operation of the joining device so as to:
insert, in the joining of the first current collecting bundle portion to the lead, the joining tip portion of the first joining tool into the gap from the distal end at an attitude at which the projection protrudes toward the first current collecting bundle portion and the back surface faces the second current collecting bundle portion; and
insert, in the joining of the second current collecting bundle portion to the lead, the joining tip portion of the second joining tool into the gap from the distal end at an attitude at which the projection protrudes toward the second current collecting bundle portion and the back surface faces the first current collecting bundle portion.

8. The joining device of claim 1, further comprising: a joining tool that is shared in joining of the first current collecting bundle portion and the second current collecting bundle portion to the lead,
wherein the controller is configured to control the operation of the joining device so as to:
insert, in the joining of the first current collecting bundle portion to the lead, the joining tool into the gap, thereby applying the pressure to the first current collecting bundle portion in a state in which the joining tool is inserted in the gap; and
invert, in the joining of the second current collecting bundle portion to the lead, the joining tool in the thickness direction of the electrode group from an attitude of the joining tool during joining of the first current collecting bundle portion to the lead, and configured to insert the joining tool into the gap, thereby applying the pressure to the second current collecting bundle portion in the state in which the joining tool is inserted in the gap.

9. The joining device of claim 8, wherein
the joining tool includes a joining tip portion,
an outer surface of the joining tip portion of the joining tool includes a distal surface that forms a distal end of the joining tip portion, a projection that protrudes to one side in a thickness direction of the joining tip portion, the thickness direction crossing a distal direction of the joining tip portion, and a back surface that faces an opposite side to a side on which the projection protrudes in the thickness direction of the joining tip portion,
the back surface of the joining tip portion of the joining tool includes an inclined surface that is inclined with respect to the distal direction in a state in which the inclined surface extends closer to the side on which the projection protrudes in the thickness direction of the joining tip portion, as the inclined surface extends closer to the distal end of the joining tip portion, and
the controller is configured to control the operation of the joining device so as to:
insert, in the joining of the first current collecting bundle portion to the lead, the joining tip portion of the joining tool into the gap from the distal end at an attitude at which the projection protrudes toward the first current collecting bundle portion and the back surface faces the second current collecting bundle portion, and
insert, in the joining of the second current collecting bundle portion to the lead, the joining tip portion of the joining tool into the gap from the distal end at an attitude at which the projection protrudes toward the second current collecting bundle portion and the back surface faces the first current collecting bundle portion.

10. A joining method comprising:
joining, for an electrode group in which a first current collecting bundle portion and a second current collecting bundle portion are arranged in a thickness direction with a gap being interposed, the first current collecting bundle portion to a lead by applying pressure to the first current collecting bundle portion from at least one side in the thickness direction; and
joining, for the electrode group, the second current collecting bundle portion to the lead by applying pressure to the second current collecting bundle portion from at least one side in the thickness direction, the second current collecting bundle portion being joined while an attitude angle of the electrode group with respect to a horizontal plane is maintained from an attitude of the electrode group during joining of the first current collecting bundle portion to the lead.

11. A manufacturing method of a battery, comprising:
joining each of the first current collecting bundle portion and the second current collecting bundle portion to the lead by the joining method of claim 10; and
electrically connecting each of the first current collecting bundle portion and the second current collecting bundle portion to a terminal via the lead.
